(19) United States
(12) Patent Application Publication
(10) Pub. No.: US 2026/0318599 A1
(43) Pub. Date: Oct. 15, 2026

(54) SYSTEMS AND METHODS FOR PRODUCING THERMALLY PROCESSED MATERIALS

(71) Applicants: Kenneth I. Armijo, Bosque, NM (US); National Technology & Engineering Solutions of Sandia, LLC, Albuquerque, NM (US)

(72) Inventors: Kenneth M. Armijo, Albuquerque, NM (US); Kenneth I. Armijo, Bosque, NM (US)

(21) Appl. No.: 19/175,313

(22) Filed: Apr. 10, 2025

(51) Int. Cl. F27B 7/14

(52) U.S. Cl. CPC F27B 7/14

(57) ABSTRACT

A system for producing thermally processed materials includes a reactor for producing thermally processed materials. A working fluid that is directly heated by solar energy is contacted with the materials to thermally treat the materials.

### STATEMENT REGARDING FEDERALLY SPONSORED RESEARCH OR DEVELOPMENT

This invention was made with Government support under Contract No. DE-NA0003525 awarded by the United States Department of Energy/National Nuclear Security Administration. The Government has certain rights in the invention.

### BACKGROUND

Traditional, industrial material heat processes rely heavily on fossil fuels, primarily natural gas or oil, to generate the high temperatures required. For example, the roasting of coffee, chocolate, and brewery grain rely heavily on fossil fuels. These methods pose several challenges, particularly in terms of operational efficiency and environmental impact from the significant CO₂ emissions generated by those processes.

As industries worldwide seek to reduce their carbon footprints, the reliance on non-renewable energy sources has become increasingly unsustainable. CO₂ emissions contribute to climate change and regulatory bodies are enforcing stricter limits on industrial carbon outputs. Companies engaged in large-scale operations face rising costs associated with carbon taxes, emissions abatement measures, and compliance with environmental regulations. The transition away from fossil fuels is therefore essential to meet both current and future sustainability goals.

Additionally, energy and heating costs in traditional systems can be high due to the volatility of fossil fuel prices and the inefficiencies inherent in combustion-based heating. This economic burden is amplified in regions where energy resources are scarce or expensive. Industrial heating/roasting operations often require consistent, high-temperature heat, which places continuous demand on fuel sources, leading to increased operational expenses.

In addition to sustainability, there is a growing need for heating/roasting systems that provide volumetric heating, rather than surface heating, to achieve better uniformity and efficiency. Traditional roasting methods often rely on heat applied externally, causing uneven roasting as the outer layers of the material heat faster than the core. Volumetric heating systems, which distribute heat more evenly throughout the entire volume of the raw materials, would ensure a more consistent roasting process. This technology would allow enhanced control for drying, milliard and roasting processes. This not only improves product quality but also enhances energy efficiency by reducing the time and energy required to achieve uniform roasting temperatures. Such systems could lead to significant advancements in industrial roasting processes, combining environmental benefits with improved operational performance.

Given these issues, there is a growing need for sustainable, thermal processing technologies that can provide more controllable, high-temperature heat without the negative environmental impacts associated with fossil fuels.

### SUMMARY

The systems, methods, and devices of the present disclosure include a vessel and other elements that thermally process materials using a working fluid directly heated by solar energy.

According to an embodiment of the disclosure, a vessel for producing thermally processed materials is disclosed that includes an outer drum defined by an inner volume bounded by two opposed axial ends of the outer drum and a longitudinal side wall of the outer drum extending between the two opposed axial ends; a material cage disposed inside the inner volume of the outer drum, wherein the material cage includes at least one aperture configured to allow the working fluid to pass between an inside and an outside of the material cage. The material cage is configured to restrict raw materials from moving between the inside and the outside of the material cage. An outer annular space is formed between an inside of the longitudinal side wall of the outer drum and an outside of the material cage. A material motivator configured to facilitate movement of the raw material held in the material cage while the working fluid is received in the inner volume of the outer drum from a remote working fluid heating station.

According to another embodiment of the disclosure, a solar processing system for producing thermally processed materials is disclosed that includes a vessel including an outer drum having two opposed axial ends and a longitudinal side wall extending between the two opposed axial ends and an inner tubular member extending through an inner volume of the outer drum, wherein the outer drum is configured to contain raw materials in the inner volume; a solar collector configured to heat a working fluid; and heat transfer pipes configured to convey the working fluid heated by the solar collector into the vessel, wherein the working fluid received in the vessel is configured to heat the raw materials for thermal processing.

According to another embodiment of the disclosure, a method of producing thermally processed materials is disclosed that includes loading raw materials into a vessel for producing thermally processed materials from the raw materials; heating a working fluid with a solar collector; and circulating the working fluid heated by the solar collector inside the vessel. The working fluid received in the vessel is configured to heat the raw materials for thermal processing. The vessel includes an outer drum having two opposed axial ends and a longitudinal side wall extending between the two opposed axial ends and an inner tubular member extending through an inner volume of the outer drum. The outer drum is configured to contain the raw materials in the inner volume.

An advantage of the present disclosure is that materials may be thermally processed without generating CO₂.

Another advantage of the present disclosure is the controlled thermal processing of the materials.

These and other features, objects, and advantages of the present disclosure will be further understood and apparent from the following specification, claims, and appended drawings.

### BRIEF DESCRIPTION OF THE DRAWINGS

The accompanying drawings, which are incorporated herein and constitute part of this specification, illustrate exemplary embodiments of the invention, and together with the general description given above and the detailed description given below, serve to explain the features of the invention.

FIG. 1 illustrates a solar processing system for producing thermally processed materials in accordance with various embodiments.

FIG. 2 is a schematic view of a solar processing system for producing thermally processed materials according to various embodiments.

FIG. 3A is a perspective view of a vessel for thermally processing materials according to various embodiments.

FIG. 3B is a side cross-sectional view of a vessel for thermally processing materials according to various embodiments.

FIG. 3C is a side cross-sectional view of the vessel of FIGS. 3A-3B with an alternative working fluid flow configuration according to various embodiments.

FIG. 3D is a front cross-sectional view of the vessel of FIGS. 3A-3B according to various embodiments.

FIG. 3E is a front cross-sectional view of the vessel of FIG. 3D with hatches open according to various embodiments.

FIG. 3F is a side cross-sectional view of the vessel of FIGS. 3A-3B with alternative working fluid inlets according to various embodiments.

FIG. 3G is a front cross-sectional view of the vessel of FIG. 3F according to various embodiments.

FIG. 4A is perspective view of a vessel for thermally processing materials according to various embodiments

FIG. 4B is a side cross-sectional views of a vessel for thermally processing materials according to various embodiments.

FIG. 4C is a side cross-sectional view of the vessel of FIGS. 4A-4B with alternative manifold direction for the working fluid into the material cage according to various embodiments.

FIG. 5A is a side perspective view of a vessel for thermally processing materials continuously according to various embodiments.

FIG. 5B is a front cross-sectional view of a vessel for thermally processing materials continuously according to various embodiments.

FIG. 6 is a side perspective view of a series of vessels for continuously thermally processing materials according to various embodiments.

FIG. 7A is a side perspective view of a vessel for thermally processing materials according to various embodiments.

FIG. 7B is a front cross-sectional view of a vessel for thermally processing materials according to various embodiments.

FIG. 8A is a perspective view of a vessel that includes an inner tubular member for thermally processing materials according to various embodiments.

FIG. 8B is a side cross-sectional view of a vessel that includes an inner tubular member for thermally processing materials according to various embodiments.

FIG. 8C is a side cross-sectional view of a vessel with alternative working fluid outlets according to various embodiments.

FIG. 9 is a side perspective view of a vessel with an internal auger style material motivator for thermally processing materials continuously according to various embodiments.

FIG. 10 is a side perspective view of a series of vessels for thermally processing materials continuously according to various embodiments.

FIG. 11A is a perspective view of a vessel that includes an inner tubular member and an intermediate material motivator for thermally processing materials according to various embodiments.

FIG. 11B is a side cross-sectional view of a vessel that includes an inner tubular member and an intermediate material motivator for thermally processing materials according to various embodiments.

FIG. 12 is a perspective view of a vessel that includes an inner tubular member and an intermediate auger-style material motivator for thermally processing materials according to various embodiments.

FIG. 13A is a schematic of a method for thermally treating a material according to an embodiment of the disclosure.

FIG. 13B is a schematic of a method for thermally treating a material according to an embodiment of the disclosure.

FIG. 13C is a schematic of a method for thermally treating a material according to an embodiment of the disclosure.

FIG. 13D is a schematic of a method for thermally treating a material according to an embodiment of the disclosure.

FIG. 13E is a schematic of a method for thermally treating a material according to an embodiment of the disclosure.

FIG. 13F is a schematic of a method for thermally treating a material according to an embodiment of the disclosure.

FIG. 13G is a schematic of a method for thermally treating a material according to an embodiment of the disclosure.

FIG. 13H is process flow diagrams of methods for thermally processing materials according to various embodiments.

Wherever possible, the same reference numbers will be used throughout the drawings to represent the same or similar parts/elements.

### DETAILED DESCRIPTION

The present invention now will be described more fully hereinafter with reference to the accompanying drawings, in which preferred embodiments of the invention are shown. This invention may, however, be embodied in many different forms and should not be construed as limited to the embodiments set forth herein; rather, these embodiments are provided so that this disclosure will be thorough and complete and will fully convey the scope of the invention to those skilled in the art.

The present disclosure is directed to devices, systems and methods for producing thermally processed materials. In an embodiment, a thermal processing container, vessel or reactor for producing thermally processed materials is disclosed. The reactor includes a container having an outer wall that defines a first inner volume. In an embodiment, the container may be a drum. In other embodiments, the container may have other shapes, such as but not limited to a cylinder or drum, a square, a rectangle or a multi-faceted geometry.

Inside the first inner volume is an inner container or cage having an outer wall that defines a second inner volume. An open space is defined between the container and inner container outer wall. The inner container outer wall has a plurality of apertures that allows the movement of a working fluid across the outer wall and between open space and the second inner volume. In such a manner, a working fluid can transfer between the open space and the second inner volume while the inner container outer wall contains a material to be thermally processed. A conveyance system is included to move and/or mix the raw materials within the cage.

In some embodiments, the working enters the open space via an inlet at the axial end of the container or an inlet through the outer wall and exist via outlets in the opposing axial end or outer wall. In other embodiments, the working fluid may be distributed within the inner container via an inner distributor within the inner container. The working fluid can then be discharged from the container via outlets in the outer wall. The container and cage include controlled openings or hatches for adding or removing materials to the cage.

In an embodiment, the convenance system may consist of a rotational drive assembly that rotates the cage inside the outer drum. In some embodiments, the cage is horizontal and includes no devices for moving the material axial and so the material is simply mixed in a batch process. In some embodiments, the cage may include protrusions, such as blades to assist in mixing the material as the cage rotates. In some embodiments, the cage and/or container may be inclined so that material conveys or moves axial through the cage from the higher inclined end to the lower inclined end in a continuous or semi-continuous process. In such embodiments, the material may be fed into and removed from the cage at or near the axial ends of the cage, the feed being at or near the higher axial end. In the continuous or semi-continuous process, the material may be conveyed through the cage by a rotary auger, paddle conveyor, pneumatic conveyor, vibratory conveyor, and/or as discussed above, an inclined surface of the cage created by inclining the cage.

In an embodiment, an inner tubular member may extend longitudinally through the cage, concentrically aligned and passing through the material cage. The tubular member includes apertures along its length, allowing a working fluid to pass through and be dispersed into the cage inner volume. In certain embodiments, the conveyance system is configured to rotate the material cage around the inner tubular member, forming an inner annular space between the inside of the material cage and the outer surface of the tubular member. In other embodiments, the cage and inner tubular member may rotate together.

In an embodiment, the system may further include a manifold located at one of the axial ends of the container configured to distribute the working fluid into the container. In other embodiments, the system may include a manifold that distributes the working fluid into the container inner space through inlets in the container outer wall. In an embodiment, the inlets may be distributed along the axial length of the container. In an embodiment, materials can be introduced into the cage from one axial end, while the working fluid may enter the container and/or inner tubular member from the opposite axial end. In other embodiments, the material and working fluid may be introduced into the same axial end.

The working fluid used in the system to heat the material may be air or carbon dioxide. The working fluid is heated by exposure to concentrated solar irradiance. In an embodiment, the working fluid may be heated by a solar parabolic trough. In other embodiments, the working fluid may be heated by other solar heating arrangements, such as but not limited to concentrating mirrors, a solar dish, a Fresnel dish and a linear Fresnel heliostat. The working fluid may be heated and directly provided to the reactor and/or may be stored prior to being provided to the reactor. In an embodiment, the working fluid storage may be in an insulated container.

Another aspect of the invention includes a solar processing system for producing thermally processed materials. The system incorporates the described vessel and further includes a solar collector configured to heat the working fluid. Heat transfer pipes convey the heated fluid into the reactor, where it heats the raw materials for thermal processing. The system may also feature a storage tank for the working fluid, which is connected to heat transfer pipes between the solar collector and the reactor. In some configurations, the reactor includes an exit port for removing the working fluid after it has heated the raw materials, with heat transfer pipes recycling the removed fluid for reheating by the solar collector.

Other aspects of the invention include methods for producing thermally processed materials. The methods involve heating a working fluid using solar heating, loading materials into a vessel that features an outer drum and inner cylindrical member, and thermally treating the materials with the working fluid. The heated fluid is circulated through the vessel where it heats materials. After thermal processing, the thermally processed materials are removed. The thermally processed materials can be removed via a hatch in the vessel or by an outlet that continuously discharges the material. In an embodiment, the method may include using a conveyor inside the vessel to move the raw or processed materials longitudinally to an outlet.

The working fluid may be introduced to the material via a central, or outer annular, distribution system that runs the axial length of the inner vessel and/or circulated into an outer annular space or through apertures in the longitudinal side wall, directing the fluid toward the raw materials.

The various embodiments described herein offer several advantages over traditional roasting systems. For example, the ability to use a working fluid heated by a remote station, such as a solar heating system, which significantly reduces reliance on fossil fuels and lowers CO2 emissions. This system enhances energy efficiency by utilizing renewable energy sources, providing a more sustainable roasting process while minimizing the operational costs associated with volatile fuel prices. The working fluid can be efficiently directed into the vessel, ensuring optimal heat transfer to the raw materials inside, which contributes to a more controlled and uniform thermal processing environment.

Another advantage of various embodiments is the capability for inside-out heating, where the working fluid flows through an inner tubular member inside the vessel, providing volumetric heating. This approach ensures that the raw materials are heated more evenly from within the material cage, as opposed to surface heating from the outside, which can lead to uneven roasting. By distributing heat throughout the entire volume of the raw materials, the invention improves the uniformity of the roasting process and reduces the time and energy required to achieve the desired temperature.

The combination of convective heating with agitators or material motivators further enhances the process by promoting turbulence inside the holding chamber. This turbulence may ensure that the working fluid circulates more effectively around and through the raw materials, enhancing heat transfer and promoting even roasting. The agitators, which may include rotary augers, conveyors, or similar mechanisms, help to continually move the materials during processing, preventing hotspots and improving the overall consistency and efficiency of the heating process. This leads to higher-quality output with reduced processing times and lower energy consumption, making the system both environmentally and operationally superior.

Various embodiments offer the advantage of being adaptable into simple, relatively portable systems that can be deployed directly in agricultural settings, such as in the field. This portability enables in-situ processing or pre-processing of raw materials, such as grains, coffee beans, or other agricultural products, immediately after harvest. By utilizing a compact and mobile configuration, such as a system mounted on a trailer, the roasting apparatus can be transported to various locations, eliminating the need for centralized, large-scale roasting facilities.

This capability is particularly beneficial for pre-processing to dehydrate roasted materials, significantly reducing their weight and volume prior to transportation. By removing moisture through roasting or dehydration processes in the field, the system helps reduce the cost and logistical challenges associated with transporting heavier, unprocessed materials to distant processing plants. The combination of in-situ processing and weight reduction leads to improved efficiency in agricultural supply chains, reducing transportation costs and the overall carbon footprint of moving agricultural products. This mobile solution aligns well with sustainable practices and supports more localized and flexible production methods.

As used herein, the term “raw materials” refers to the materials that are introduced into the vessel for processing. The raw materials may even comprise or include materials previously processed in some way, at least partially, before being introduced into the vessel for processing. These materials may vary in composition, form, and size, depending on the intended thermally processed output. The raw materials may undergo physical or chemical changes during processing as they are exposed to the heat transferred from the working fluid.

As used herein, the term “working fluid” refers to a fluid that is heated, by a remote source, and introduced into the vessel to transfer heat to the raw materials and/or thermally processed materials being further thermally processed. The working fluid may include, but is not limited to, air, carbon dioxide, other gases, or mixed state fluids capable of effectively transferring thermal energy. The working fluid is circulated through the vessel and may be directed through apertures or spaces within the structure to facilitate heat transfer.

As used herein, the term “thermally processed materials” refers to the output materials resulting from the application of heat to raw materials inside a vessel. These materials may undergo various physical or chemical transformations, depending on the nature of the raw materials and the conditions of thermal processing.

As used herein, the expression “direct solar heating process” refers to a method of heating a working fluid using solar energy and contacting that working fluid directly with a material in a vessel to be heated or thermally treated or processed.

Various embodiments are described in the context of processing beans, peppers, grains, green biomass (e.g., seaweed, leafy vegetables, etc.) and/or coffee. However, the various embodiments described herein are not limited to the processing of beans, peppers, grains, green biomass and coffee, and are capable of handling a wide range of raw materials across various industries. These materials may include grains, seeds, nuts, spices, and legumes, which are commonly roasted or dried for use in food products. In addition, the system is well-suited for the processing of herbs, fruits, and vegetable products, which can be dehydrated or roasted to enhance flavor, shelf life, or nutritional content. Beyond agricultural products, various embodiments can be adapted for use with biomass materials, such as wood chips or agricultural waste, for applications in energy production or biofuel generation.

Although various embodiments are described herein as related to food roasting, it should be understood that the embodiments described herein are versatile and can be applied to the treatment of non-food materials. For example, they may be used to thermally process industrial materials, such as drying or cracking certain raw chemical or biological compounds. In other embodiments, the system may be used in the processing of feedstock materials for bioenergy, where controlled heating is essential for breaking down organic matter efficiently.

Moreover, various embodiments of the invention are adaptable for different types of raw material heating. For instance, the system may be used for drying agricultural products to remove moisture and prepare them for storage or transport. Various embodiments can also be configured for cracking materials, a process in which heat causes chemical or physical changes to the raw materials, breaking them down into smaller components. Other possible applications include toasting, baking, or smoking materials to achieve specific product characteristics. This flexibility makes the invention applicable to a wide range of industries and processes, far beyond food production alone.

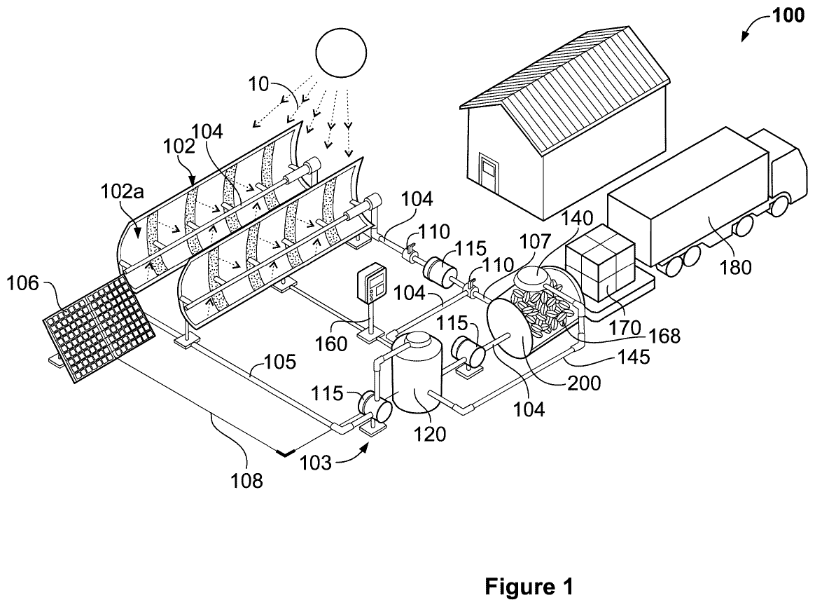

FIG. 1 is a schematic perspective view of a solar processing system 100 for producing thermally processed materials in accordance with various embodiments. The solar processing system 100 for producing thermally processed materials utilizes solar flux or radiation 10 in a direct solar heating process to heat a working fluid to treat a variety of raw materials. The system 100 includes a solar collector 102. In other embodiments, the system 100 may include one or more solar collectors 102. In this exemplary embodiment, the solar collector 102 includes five solar concentrators 102a. In other embodiments, the solar collector 102 may include one or more solar concentrators, dishes, panels, Fresnel heliostat, heliostats, parabolic troughs and/or mirrors that focus sunlight onto a fluid conduit 104 to heat a working fluid contained therein. In this exemplary embodiment, the fluid conduit 104 is a single pipe traversing the solar collector 102. The fluid conduit 104 is a component of a fluid system 103. In other embodiments, the fluid conduit 104 may be one or more pipes or conduits. The conduit 104 is configured to convey the working fluid heated by the solar collector 102 to a reactor or vessel 200. The working fluid may be a gas or multi-phase material such as but not limited to air and carbon dioxide.

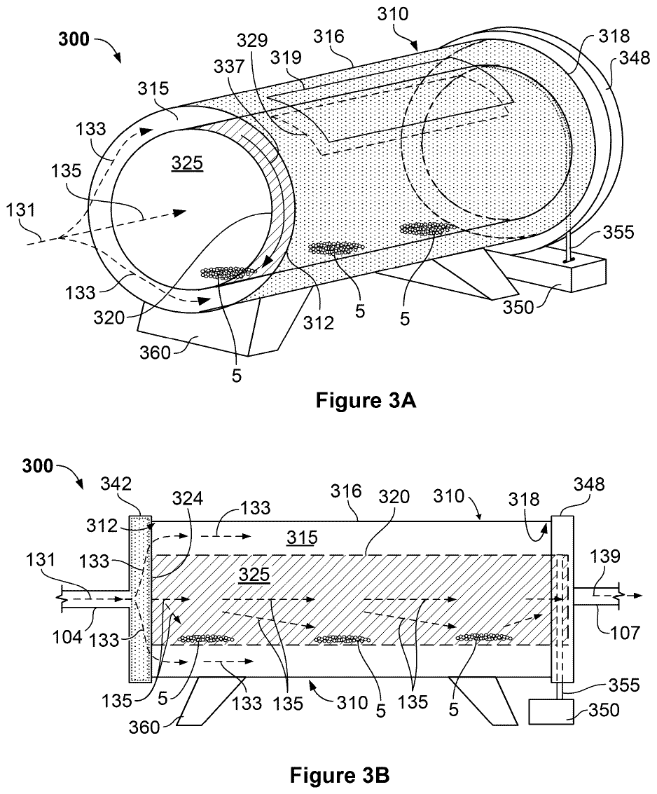

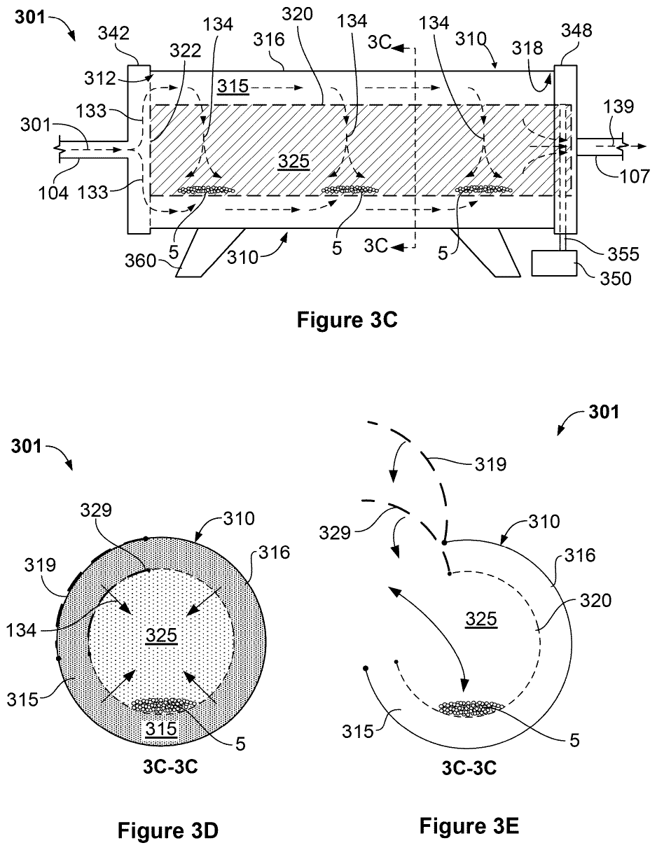

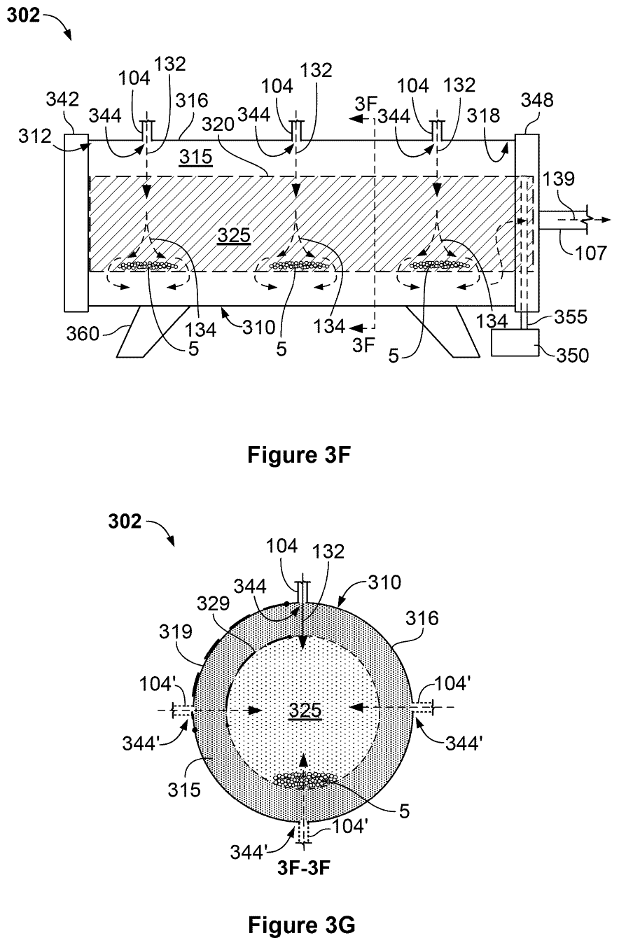

In the vessel 200, the working fluid contacts and directly heats a raw material. In FIG. 1, an outer drum 310 (see FIGS. 3A-G, etc.) of the vessel 200 has been removed for clarity. In this exemplary embodiment, the vessel 200 is cylindrical. In other embodiments, the vessel may have other geometries such as but not limited to rectangular and square.

The fluid system 103 further includes valves 110 and pumps 115 that control the flow of the working fluid to ensure that the fluid is delivered efficiently to the vessel 200. After use in the vessel 200, the working fluid can either be recirculated back into the vessel 200 through recirculation conduits 107, stored in a storage reservoir 120, or returned for reheating by the solar concentrators 102 through return conduits 104.

In this exemplary embodiment, the system 100 additionally includes a solar panel 106. In this exemplary embodiment, the system 100 includes one solar panel 106, however, in other embodiments the system 100 may include one or more solar panels. The solar panel 106 may include an inverter for converting DC to AC. The solar panel 106 is electrically connected by conductive lines 108 to pumps 115 and a system controller 160. In other embodiments, the solar panel 106 may be also connected to one or more heaters (not shown but well understood in the art) in the working fluid flow path including in the vessel 200 to heat or supplementally heat the working fluid. In other embodiments, the solar panel 106 may be electrically connected to other pumps, valves and other system control devices to control the distribution and flow of the working fluid.

The system controller 160 controls the operation of one or more components and/or functions of the system 100 to ensure optimal performance. Processed materials 168, once thermally treated in the vessel 200, are collected, boxed, or packaged 170, and transported using a transportation system 180 for delivery, further processing, and/or further use.

In this exemplary embodiment, the system 100 further includes a thermal reservoir 120 that holds or stores the working fluid prior to delivery to the vessel 200. In other embodiments, the system 100 may include one or more thermal reservoirs 120 in fluid communication before and/or after the vessel 120. The thermal reservoir 120 may store the working fluid and/or heat from the working fluid and may be referred to as thermal storage reservoir. In an embodiments, the stored heat can heat the working fluid and/or maintain a constant fluid temperature for feeding to the vessel 200 to ensure that the system 100 can operate during periods of low solar input. In an embodiment, the storage reservoir 120 may use a solid medium such as but not limited to rocks, pebbles, or ceramic spheres to store thermal energy. The storage reservoir 120 may be insulated to minimize heat loss and can include additional heat exchangers for pre-heating the working fluid before reintroduction to the vessel 200 or return to the concentrators 102. In an embodiment, the storage reservoir 120 may be configured to hold working fluid therein, such that the storage reservoir 120 is connected to the heat transfer pipes (i.e., working fluid delivery conduit 104) between the solar concentrator 102 and the vessel 200. In other embodiments, the reservoir 120 may be omitted.

A raw material 168 is thermally processed in the vessel 200 using the heated working fluid. In this exemplary embodiment, the vessel 200 includes a recirculation and/or exhaust system 140 including that recirculates the working fluid to the reservoir 120. In an embodiment, the exhaust system may include conduits to exhaust working fluid to the environment. The working fluid may include gases, smoke and/or moisture generated during thermal procession of the materials 168. In some embodiments, the exhaust system 140 may connect to filters or scrubbers to ensure environmental compliance.

The vessel 200 includes an outlet fluidly connected to a recirculation conduit 107 designed to remove the working fluid from the vessel 200 after it has heated the raw materials. The heat transfer pipes (e.g., recirculation conduit 107 and/or return conduit 105) are configured to convey at least a portion of the removed working fluid either to a storage tank or back to the solar collector, where it can be reheated and reused in the thermal process, thereby optimizing energy efficiency in the system.

The system controller 160 may govern all operations by managing the flow of the working fluid throughout the system and ensuring optimal performance based on real-time conditions. It may direct the working fluid through various conduits, including working fluid delivery conduit 104 and return conduits 105, ensuring that fluid flows efficiently between the solar concentrators 102 and vessel 200, as well as to the storage reservoir 120. The controller 160 may regulate the operation of valves 110, such as diverter valves, to route the working fluid as needed, whether toward the vessel 200 for processing, into the recirculation conduits 107, or back to the solar concentrators 102 for reheating. It also may control the pumps 115 to maintain proper flow rates and pressure throughout the system, ensuring the working fluid reaches its target destination without interruption.

In an embodiment, the controller 160 may continuously monitor the temperature of the working fluid and determine when supplemental heating may be required. If solar input is insufficient, such as during cloudy periods or at night, the controller 160 can engage a supplemental heater to raise the temperature of the working fluid to the required level. Alternatively, the controller may initiate recirculation of the working fluid through the solar concentrators 102 to maximize the available solar energy. In some cases, the controller can coordinate energy input from solar panels 106, using the electricity generated to power auxiliary components like pumps, heaters, or automated valves. This integrated control ensures that the system operates efficiently and maintains consistent thermal conditions for processing, minimizing energy waste and optimizing heat management throughout the entire process.

Processed materials 170, once treated in the vessel 200, may be collected and prepared for transportation or further processing. These materials can be boxed, bagged, or otherwise packaged according to industry needs. The transportation system 180, which may include motor vehicles (e.g., trucks), conveyors, or rail systems, ensures the efficient movement of the processed materials to their final destination or distribution point. This integrated transportation system facilitates a seamless transition from thermal processing to delivery, minimizing delays and improving the overall efficiency of the production process.

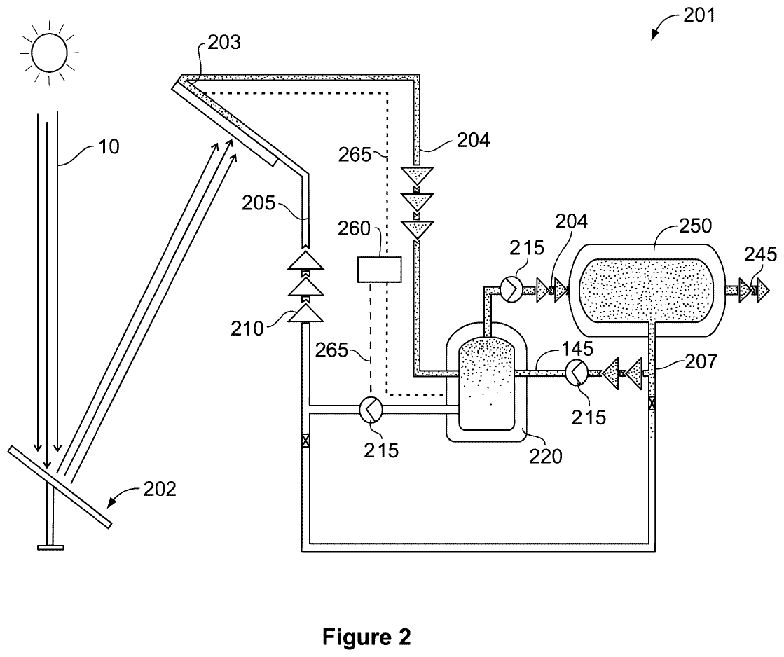

FIG. 2 is a schematic of a solar processing system 201 for producing thermally processed materials according to various embodiments. The system 201 includes a concentrated solar receiver 203 that receives concentrated solar energy, light or flux from a heliostat or mirror 202 that reflects sunlight 10. The system 201 includes a conduit 204 that passes through the receiver 203 allowing the conduit to be heated by the sunlight received by the receiver 203. A working fluid within the conduit is heated by the solar flux. In this exemplary embodiment, the system 201 includes one conduit passing through the receiver 203, however, in other embodiments one or more conduits may pass through the receiver 203. In an embodiment, the receiver 203 may be of a configurations referred to in the discussion of FIG. 1 above.

A working fluid passing through the conduit 204 and heated in the receiver 203 is then received by the reservoir 220 before being delivered to the vessel 250 to heat a material for thermal processing. The storage reservoir 220 may serve as an intermediary, storing the heated working fluid until needed, ensuring consistent thermal energy availability even when solar input fluctuates. When required, the working fluid flows from the storage reservoir 220 through delivery conduit 204 to the vessel 250, where it thermally processes the materials. After use in the vessel 250, the working fluid is directed back to the storage reservoir 220 via recirculation conduits 207, enabling efficient reuse and minimizing heat loss. In other embodiments, the fluid may be provided directly partially or in full to the receiver 203 from the vessel 250 as described in the embodiment of FIG. 1.

In an embodiment, a system controller 260 may govern the operation of the system 201, ensuring proper coordination between the receiver 203, valves 210, pumps 215, storage reservoir 220, and the vessel 250. The controller 260 may be electrically coupled to these elements, such as through wiring 265 (only partially shown for simplicity), allowing it to monitor and regulate various operational parameters, such as temperature and pressure, via sensors incorporated into these components. This ensures precise control over the flow and temperature of the working fluid, maintaining optimal conditions for thermal processing. The controller 260 can adjust the operation of the receiver 203 and pumps 215 based on sensor feedback, routing the working fluid appropriately to maximize efficiency. By managing the flow of fluid between the receiver 203, storage reservoir 220, and vessel 250, the system ensures that sufficient thermal energy is available at all times, improving energy efficiency and ensuring consistent material processing.

FIGS. 3A-3G illustrate vessels 300, 301, 302 for thermally processing materials according to various embodiments. The vessels 300, 301, 302, represent examples of the vessel 200 and 250 described above, and are configured to receive raw materials 5 for thermal processing, allowing for flexibility in how the materials are loaded. The raw materials 5 may be introduced into the vessels in different configurations, depending on the type of material, the desired processing characteristics, and the specific thermal treatment required. For example, the materials can be loaded all in a heap, where the raw materials are simply deposited in a single mass. This method may be suitable for materials that do not require careful arrangement for even processing, allowing for quick and efficient loading.

Alternatively, the raw materials 5 may be spread out evenly within the vessel. This approach ensures uniform exposure to the working fluid, which can lead to more consistent thermal treatment, especially for materials sensitive to uneven heating. By distributing the materials evenly across the entire caged volume, heat or fluid flow can penetrate more thoroughly, improving the overall quality of the thermal process.

In other embodiments, the raw materials 5 may be arranged in multiple separate piles or sections within the vessel (e.g., as shown in FIGS. 3A-3C, 3F). This method allows for different materials to be processed simultaneously or for staged processing, where each pile may experience slightly different conditions. This flexibility can be advantageous when processing materials that vary in size, density, or composition, as it allows for tailored treatment of each batch. These various loading configurations provide operational versatility, ensuring that the vessels 300, 301, 302 can accommodate a wide range of materials and batch types for effective and efficient thermal processing.

The vessels 300, 301, 302 are also configured to receive a delivered working fluid flow 131, 132 from the delivery conduit 104, which flow 131, 132 is made to circulate inside the vessel 300, 301, 302 for processing the raw materials 5. After circulating inside the vessel 300, 301, 302, the recirculation conduit 107 may carry away exiting working fluid flow 139, which may be recirculated back into the vessel 300, 301, 302, directed to the storage reservoir 120, or returned to be reheated by the solar concentrator 102. Once the raw materials 5 are thermally processed as needed or desired, one or more of the loaded batches of raw materials 5 may be removed (e.g., via hatches) and the vessels 300, 301, 302 may be loaded again with more raw materials 5, if desired, to repeat and/or continue the process.

FIGS. 3A-3B show a vessel 300 for thermally processing materials in accordance with various embodiments. FIG. 3A shows the vessel 300 with a proximal end manifold (e.g., 342 in FIGS. 3B, 3C, and 3F) removed for ease of explanation. The vessel 300 includes an outer drum 310, a material cage 320, and a material motivator in the form of motor 350 configured to rotate the material cage 320. The outer drum 310 is defined by an inner volume (e.g., annular space 315 plus caged volume 325) bounded by two opposed axial ends 312, 318 of the outer drum 310 and a longitudinal side wall 316 of the outer drum 310 extending between the two opposed axial ends 312, 318. The outer drum 310 forms an outer structure of the vessel 300 that encloses the inner volume where the raw materials 5 and working fluid may be contained for thermal processing of the raw materials 5. The outer drum 310 may feature apertures to allow fluid flow or hatches for the addition or removal of raw materials 5. Serving as the larger containment structure, the outer drum 310 houses the vessel's internal components, facilitating the thermal processing of raw materials 5.

While the outer drum 310 is illustrated as being cylindrical, alternative configurations are also possible. For instance, the outer drum 310 may take the form of a rectangular or polygonal prism, or a structure with elliptical or irregular cross-sections, depending on the specific design requirements and intended applications. Non-cylindrical structures may be advantageous for certain processes, such as accommodating larger or irregularly shaped materials, or for use in space-constrained environments where a cylindrical design may be impractical. These alternative designs still perform the same essential function of enclosing the inner volume and providing support for fluid circulation and material handling, ensuring flexibility across various industrial applications.

The material cage 320 is positioned inside the inner volume of the outer drum 310 and includes at least one aperture that allows the working fluid to pass between the inside and outside of the material cage 320. While enabling fluid flow through the material cage 320 outer walls, the material cage 320 is designed to restrict the movement of raw materials 5, preventing them from escaping from within the material cage 320 to outside the material cage 320. An outer annular space 315 is formed between the inner surface of the longitudinal side wall 316 of the outer drum 310 and the exterior of the material cage 320, facilitating the circulation of the working fluid around the raw materials 5 held inside the material cage 320.

The inner volume is defined as all the space enclosed within the boundaries of the outer drum 310, including the area contained by the longitudinal side wall 316, as well as the space between the opposed axial ends 312, 318 of the outer drum 310. This inner volume serves as the primary processing environment for containing the working fluid and circulating that working fluid around the raw materials 5 during the thermal process. Since the material cage 320 is disposed within this inner volume, it creates the caged volume 325, which defines a subspace of the inner volume. Specifically, the material cage 320 defines a caged volume 325 inside its boundaries, designed to hold the raw materials 5 being processed. The structure of the material cage 320 includes apertures (e.g., perforations or other openings) that allow the working fluid to pass freely between the interior and exterior of the material cage 320, ensuring effective heat transfer to the materials inside while preventing the raw materials from escaping the cage.

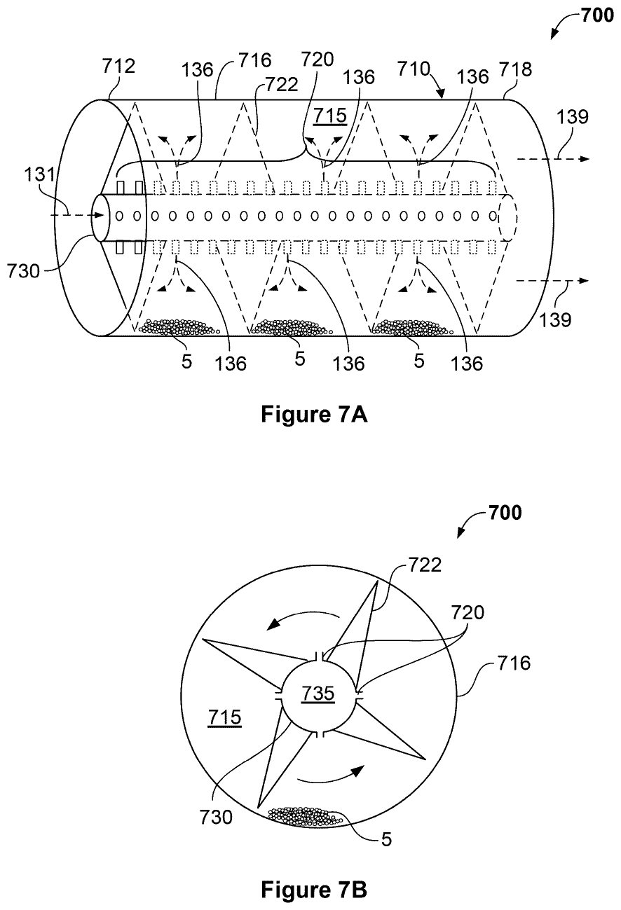

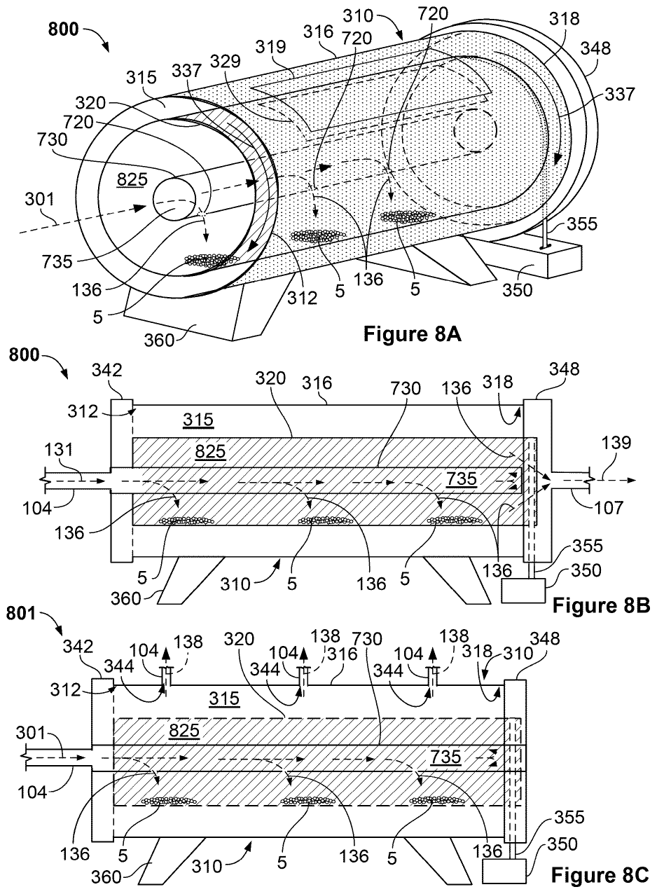

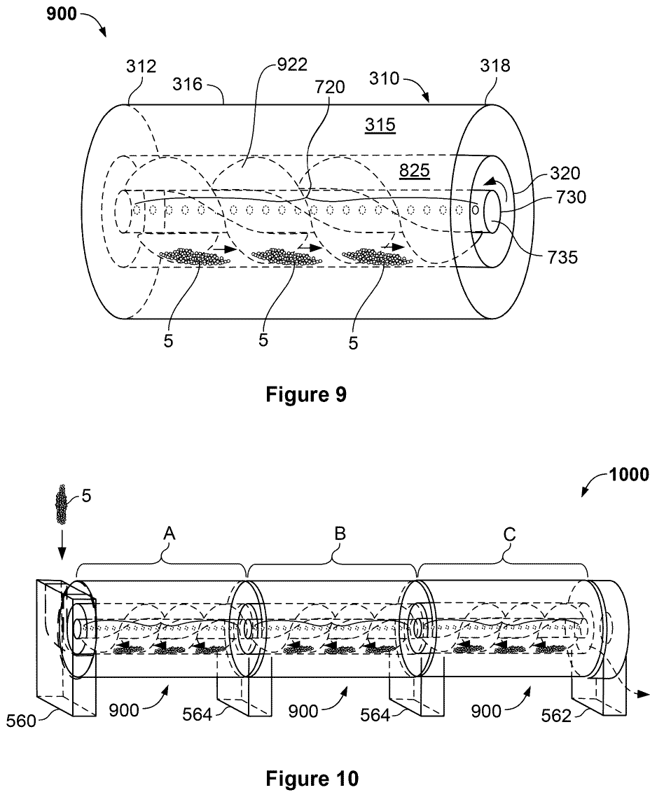

Outside the material cage 320, an outer annular space 315 is formed between the inner surface of the longitudinal side wall 316 of the outer drum 310 and the outer surface of the material cage 320. The outer annular space 315 refers to a space formed between two concentric structures, such as the outer drum 310 and the material cage 320, or the material cage 320 and another element (e.g., inner tubular member 730 in FIGS. 7A-7B or 8A-C, FIG. 9). This annular space 315 provides a path for the working fluid to circulate around the material cage 320, ensuring that the fluid flows evenly across the exterior surface of the material cage 320. This inner tubular member may be heated via impedance or ohmic heating, where electricity may come from energy agnostic sources such as solar photovoltaics, wind energy or the electric grid generally. The combination of the caged volume 325 and the outer annular space 315 within the inner volume of the outer drum 310 allows for controlled interaction between the working fluid and the raw materials 5, promoting uniform heating and efficient processing.

The material cage 320 may serve the dual function of retaining the raw materials 5 within the caged volume 325 and facilitating working fluid flow to ensure even heat distribution throughout the raw materials 5. As used herein, the terms “aperture” or “apertures” refer to openings or perforations in a structure, such as the outer drum, material cage, and/or other elements. The apertures may vary in size, shape, positioning, and arrangement depending on the specific raw materials being processed and the desired flow and/or heat transfer characteristics of the working fluid. The material cage 320 may incorporate different configurations that provide one or more apertures, such as perforated walls, mesh screens, gridded frameworks or porous structure, all designed to allow working fluid to pass freely while preventing the raw materials 5 from passing through the material cage 320.

The design of the material cage 320 may vary significantly to accommodate different processing needs. For instance, it may take the form of a cylindrical drum, which rotates 337 or remains stationary, promoting continuous material exposure to the working fluid. Alternatively, the material cage 320 could be a planar structure, such as trays or shelves, arranged to hold materials in thin layers to optimize fluid contact. Other embodiments might feature segmented cages or multi-chambered structures that allow different batches of materials to be processed simultaneously, or configurations that enable staged or sequential processing within the same vessel. These design variations ensure the versatility of the material cage 320 across various applications, from roasting and drying to cracking and pre-processing.

In addition, the material cage 320 may include adjustable or removable apertures, allowing operators to modify the size and pattern of the openings to match the characteristics of different working fluids or raw materials. For example, finer apertures may be used for small grains or powders to prevent leakage, while larger openings may be employed for bulkier materials such as coffee beans or nuts. The material cage's ability to maintain the position of the raw materials while permitting thorough fluid circulation ensures controlled and efficient thermal processing, reducing the likelihood of uneven heating or hotspots. This design enhances the overall efficiency and quality of the roasting, drying, or cracking processes within the vessel.

The vessel 300 includes a “material motivator” in the form of a rotational assembly that is configured to rotate the material cage 320 inside the outer drum 310 and includes a motor 350 that is configured to drive a belt 355 that wraps around the material cage 320. In accordance with various embodiments, the material cage 320 is configured to rotate, such as through bearings, mounts, and couplings to the intake and outlet manifolds 342, 348. For example, the intake and outlet manifold 342, 348 may include bearing surfaces that rotationally support the material cage 320. In this way, the motor 350 may circulate the belt 355 around the material cage 320, which in turn causes the material cage 320 to rotate about its longitudinal axis. As used herein, the term “material motivator” refers to one or more components, elements, and/or aspects of the vessel that facilitate the movement of raw materials within the material cage and/or the vessel. The material motivator may include mechanical devices such as a rotary auger, paddle conveyor, pneumatic conveyor, vibratory conveyor, or other mechanisms capable of moving the materials 5 longitudinally or rotationally during thermal processing. The material motivator may ensure uniform exposure of the raw materials to the working fluid.

In addition, or as an alternative, to driving the rotation of the material cage 320, the motor 350 and belt 355 may be configured to induce vibrations in the material cage 320. These vibrations can agitate the raw materials 5 within the caged volume 325, promoting continuous movement and preventing the raw materials 5 from clumping or settling during thermal processing. Vibratory motion can enhance the exposure of the raw materials 5 to the working fluid by ensuring that the material is constantly shifting, thereby improving uniformity in heating or drying.

In some embodiments, the material motivator may also include supports for the material cage 320 or the entire vessel 300 that are designed to create an incline from the horizontal plane. For example, the mounting stand 360 of the vessel 300 may include different heights at opposite ends that maintain the first axial end 312 of the material cage 320 elevated relative to the second axial end 318 of the material cage 320 along a longitudinal extent of the material cage 320. This inclined configuration encourages the raw materials 5 to slide or move gradually down the length of a bottom inner surface of the material cage 320, facilitating controlled progression of the material through the vessel 300. This movement along the incline, whether through gravity or vibration, ensures that the raw materials 5 is evenly processed as it travels through the working fluid, further enhancing the efficiency and uniformity of the thermal treatment.

As shown in FIGS. 3A-3B, the vessel 300 receives an axially delivered working fluid flow 131 at the axial end 312 of the outer drum 310. The intake manifold 342, which is attached to the axial end 312, is configured to capture this incoming working fluid flow 131 and distribute it within the vessel 300 as both an annular working fluid flow 133 and an axial working fluid flow 135. The axial working fluid flow 135 is directed along the longitudinal axis of the vessel 300, allowing it to flow into, across, and/or around the raw materials 5 held within the material cage 320. This flow pattern ensures effective heat transfer by directly exposing the raw materials 5 to the working fluid as it moves along the axial path.

Simultaneously, the intake manifold 342 distributes part of the incoming working fluid as an annular working fluid flow 133, which circulates around the exterior of the material cage 320 within the outer annular space. The annular flow 133 can then permeate through the apertures of the material cage 320 and enter the caged volume 325, allowing the working fluid to flow into, across, and/or around the raw materials 5 from multiple directions. This combination of axial and annular flows 133, 135 promotes thorough and uniform exposure of the raw materials 5 to the heated working fluid, enhancing the overall efficiency and consistency of the thermal process.

At the opposite end of the vessel 300, the outlet manifold 348 facilitates the removal of the working fluid by channeling it into the exiting working fluid flow 139, which is directed toward the recirculation conduit 107. This recirculation system allows the working fluid to either be reheated and reused or directed to a storage reservoir 120 for future use. The coordinated flow patterns provided by the intake manifold 342 and outlet manifold 348 ensure that the working fluid circulates efficiently through the vessel 300, maximizing heat transfer while minimizing energy loss.

As used herein, the term “manifold” refers to a fluid distribution or collection structure located at one of the axial ends of the outer drum. The manifold is configured to receive working fluid from an external source and distribute it into the vessel or, conversely, to collect working fluid after it has circulated through the vessel. The manifold(s) may be designed to optimize fluid flow into or out of the vessel.

In accordance with various embodiments, the vessel 300 may include one or more hatches 319, 329 to facilitate the addition of raw materials 5 into the system and the removal of thermally processed materials after treatment. These hatches may be designed to provide easy access to both the outer drum 310 and the material cage 320, streamlining the loading and unloading process without disrupting the operation of the vessel. For example, the outer drum 310 may be equipped with an outer drum hatch 319, located along the longitudinal side wall 316 of the outer drum. This hatch allows operators to load raw materials 5 directly into the inner volume or retrieve them after processing.

In addition to the outer drum hatch 319, the material cage 320 may feature its own material cage hatch 329, which provides access specifically to the caged volume 325. This material cage hatch 329 can be configured to radially align with the outer drum hatch 319, creating a direct passage for adding or removing materials from the caged volume 325. When both hatches are aligned, raw materials 5 can be easily loaded into the material cage 320, or the thermally processed materials can be efficiently removed for packaging or further processing. This dual-hatch configuration enhances the versatility of the vessel 300, enabling quick access to internal components while maintaining the containment and control needed for precise thermal treatment. The alignment of the hatches also ensures minimal disruption to the flow of the working fluid, maintaining the integrity of the thermal process during material transitions. In some embodiments, one or more of the hatches 319, 329 may be included on a bottom or lower side of the outer drum 310, in order to allow the raw materials 5 held therein to easily dump out the bottom.

As used herein, the term “hatch” refers to an opening in the outer drum, material cage, or other element that allows for the addition or removal of raw materials or thermally processed materials. The hatch may be equipped with a door or cover to seal the opening during processing and can be manually or automatically operated. The hatch may be configured to facilitate material handling without interrupting the thermal processing inside the vessel 300. Any of the hatches described herein may be actuated manually or by controls automation.

In accordance with various embodiments, FIG. 3C illustrates a vessel 301 featuring an alternative working fluid flow configuration. In this configuration, the material cage 320 includes an axial end wall 322 that contains either few or no apertures. This design alters the flow dynamics within the vessel by restricting or preventing axial working fluid flow (e.g., 135) into the caged volume 325. Specifically, in cases where the axial end wall 322 includes only a few apertures, the axial flow is limited, allowing only a small portion of the working fluid to pass axially into the material cage 320. In cases where the axial end wall 322 contains no apertures, the axial flow is fully blocked, and the working fluid is unable to enter the caged volume along the axial path.

With the axial flow restricted or eliminated, the primary or only delivery of working fluid occurs radially inward from the outer annular space 315 into the caged volume 325. This radial flow ensures that the working fluid penetrates the material cage 320 by flowing through its side apertures, allowing the heated fluid to surround, permeate, and interact with the raw materials 5 held within the caged volume 325. This inward radial delivery promotes uniform heating by ensuring that the working fluid is evenly distributed around the materials, enhancing heat transfer and preventing uneven temperature gradients that could result from axial-only flow.

This configuration may be particularly useful for applications where precise and uniform heating is critical, such as when processing materials that require slow, consistent exposure to thermal energy. By emphasizing radial fluid delivery, the vessel 301 ensures that the working fluid flows across all surfaces of the raw materials 5, improving efficiency and consistency throughout the thermal process. Additionally, the design minimizes fluid losses at the axial ends and optimizes the use of the working fluid within the vessel, further enhancing energy efficiency.

FIG. 3D provides a front cross-sectional view of the vessel 301, taken along the section line 3C-3C as shown in FIG. 3C. This view illustrates the path of the working fluid within the vessel, highlighting the flow dynamics influenced by the alternative configuration of the material cage 320. As shown, the working fluid is initially received into the outer annular space 315 through at least one of the axial ends of the outer drum 310, ensuring that the fluid enters the outer chamber that surrounds the material cage 320.

Once in the outer annular space 315, the working fluid flows radially inwardly, represented by the radially inward working fluid flow 134, toward the caged volume 325 of the material cage 320. The side apertures of the material cage 320 facilitate this radial flow, allowing the working fluid to permeate the cage and distribute evenly across the raw materials 5 contained within. This inward flow ensures that the working fluid thoroughly surrounds and interacts with the raw materials, promoting efficient and uniform heating or processing.

FIG. 3D emphasizes how the absence or limitation of axial fluid flow, as described in FIG. 3C, directs the working fluid radially from the annular space 315. This configuration optimizes heat transfer by maintaining consistent exposure to the working fluid across the entire volume of the raw materials 5, improving process efficiency and product quality while minimizing fluid loss at the axial ends

FIG. 3E presents a front cross-sectional view of the vessel 301, taken along the section line 3C-3C as shown in FIG. 3C. This figure specifically illustrates the alignment of the outer drum hatch 319 with the material cage hatch 329, demonstrating how these hatches can work together to facilitate the addition or removal of raw materials 5. When the hatches align, they create a continuous opening between the outer drum 310 and the material cage 320, allowing raw materials 5 to be easily loaded into the caged volume 325 or removed after processing. The vessel 300 may include one or more additional hatches, such as a further hatch in or near the bottom of the outer drum 310 for removing and/or cleaning out debris that made it through the material cage 320 and settled at the bottom of the outer drum 310.

This alignment of the hatches provides a streamlined method for accessing the interior of the vessel 301 without requiring disassembly or interruption of the thermal process. It allows operators to efficiently introduce new batches of raw materials or retrieve processed materials, minimizing downtime. Additionally, the alignment ensures that materials can pass directly into or out of the material cage 320 without becoming obstructed by the walls of the outer drum 310, maintaining a smooth flow during loading or unloading.

This alignment feature may be incorporated into any of the disclosed embodiments (e.g., vessel 300), regardless of the specific working fluid flow configuration or the shape of the outer drum. Whether the system operates with axial or radial fluid flow, the aligned hatches ensure easy access to the raw materials 5, enhancing both operational convenience and process efficiency.

Alternatively, the vessel 301 may include internal tubing that extends from the intake manifold 342 to one or more specific apertures within the material cage 320. This tubing directs the working fluid flow to targeted areas within the caged volume 325 in a radial direction, ensuring that the fluid reaches specific zones inside the material cage 320 where the raw materials 5 are concentrated. By channeling the fluid in this manner, the system provides a more focused and directed flow, enhancing the contact between the working fluid and the raw materials 5.

This configuration allows for precise control over the flow dynamics within the material cage 320, promoting uniform exposure and improving heat transfer efficiency. It can be particularly useful when processing raw materials that are sensitive to uneven heating, ensuring that every portion of the material receives adequate exposure to the working fluid. Additionally, the directed flow can help optimize energy usage by reducing fluid loss and ensuring that the working fluid is applied where it is most needed, further enhancing the performance and consistency of the thermal process.

FIG. 3F presents a side cross-sectional view of the vessel 302, while FIG. 3G shows a front cross-sectional view of the vessel 302 along section line 3F-3F, as indicated in FIG. 3F. These figures illustrate a configuration in which the longitudinal side wall 316 of the outer drum 310 includes one or more radial apertures 344. These apertures allow for the introduction of a radially delivered working fluid flow 132 into the outer annular space 315 and the caged volume 325. Delivery conduits 104 are coupled to the radial apertures 344, enabling precise delivery of the working fluid at multiple points along the length of the vessel 302.

As depicted in FIG. 3F, the longitudinal side wall 316 features three radial apertures 344 along its longitudinal extent; however, the system can accommodate fewer or more apertures, depending on the specific process requirements. The ability to vary the number and placement of apertures offers operational flexibility, allowing the fluid flow to be tailored to the nature of the raw materials 5 being processed and the desired thermal profile. This configuration ensures distributed fluid delivery, improving the uniformity of heating or processing across the entire volume of the raw materials 5.

In FIG. 3G, optional additional radial apertures 344′ are shown along the lateral sides or the bottom of the vessel 302. These additional apertures further enhance the working fluid distribution by enabling multi-directional flow patterns. This design ensures that the working fluid flows not only from the sides but also from below or laterally, improving heat transfer and preventing the formation of cold spots or unevenly processed material. This multi-directional fluid delivery can be especially beneficial for dense or layered raw materials, as it ensures that every portion of the material receives adequate exposure to the heated fluid, promoting consistent and efficient thermal processing throughout the vessel.

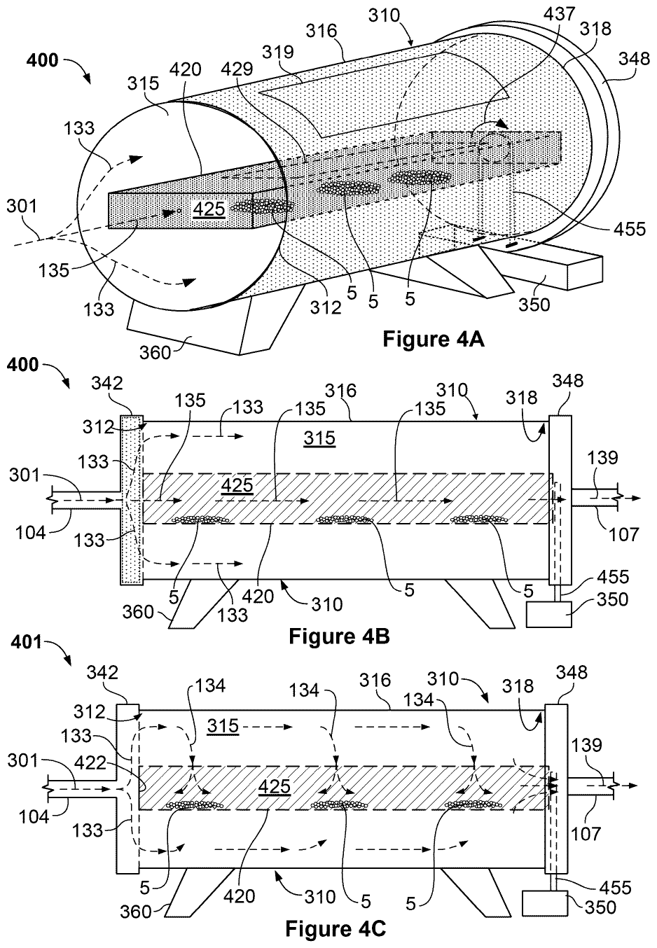

FIGS. 4A, 4B, and 4C illustrate configurations of a vessel 400 similar to those shown in FIGS. 3A, 3B, and 3C, but featuring a tray-style material cage 420. The vessel 400 represents another example of the vessel 200 described above. This tray-style material cage 420 includes a bottom inner surface that is planar, providing a planar engagement surface specifically configured to directly support the raw materials 5. The planar surface ensures stable positioning of the raw materials, allowing them to spread out evenly within the caged volume 425, which can improve the uniformity of the thermal processing. Alternatively, a material cage with a non-planar bottom may include a planar tray similar to the bottom of the tray-style material cage 420.

The tray-style material cage 420 may also include a material cage hatch 429, analogous to the hatches described earlier, facilitating the easy addition or removal of raw materials 5 from the caged volume 425. This hatch ensures convenient access to the materials, making it practical to load fresh raw materials or unload thermally processed products without significant disruption to the operation.

In this embodiment, the material motivator may utilize a modified drive belt 455 that wraps around a drive wheel smaller than the axial end of the tray-style material cage 420. This configuration allows for compact and efficient operation of the drive mechanism, ensuring smooth rotation or agitation of the material cage 420. In other embodiments, the belt 455 may be replaced by a chain or other linking drive mechanism, depending on the specific requirements of the system. Chains or linked drives offer enhanced durability and may be preferable in certain industrial applications where heavier loads or longer operating times are involved.

As illustrated in FIG. 4C, the tray-style material cage 420 may include an axial end wall 422, which functions similarly to the axial end wall 322 described for vessel 301. This axial end wall 422 can limit or prevent axial flow of the working fluid, ensuring that the fluid enters the caged volume 425 primarily through radial apertures for improved heat distribution. This design helps maintain consistent and uniform thermal exposure across the raw materials 5, enhancing the efficiency and effectiveness of the thermal processing within the vessel.

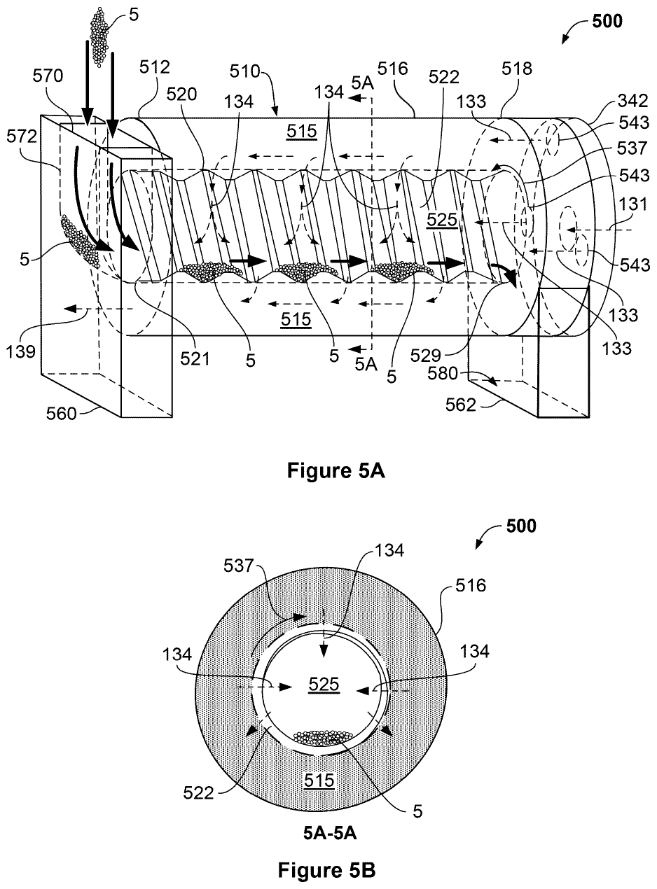

FIGS. 5A-5B illustrate a vessel 500 designed for thermally processing materials, in a continuous process, according to various embodiments. The vessel 500 represents an example of the vessel 200 described above and provides a configuration in which the raw materials 5 are fed into the vessel through one end, such as a first axial end 512, where they are gradually introduced into the processing environment. The material motivator components within the vessel are designed to move the raw materials 5 along the length of the vessel 500 while they are exposed to the working fluid, undergoing thermal processing. As the raw materials 5 progress through the vessel, they are continuously treated and eventually reach the opposed end, such as a second axial end 518, where they are automatically dumped out.

The rate at which the raw materials 5 progress from the first axial end 512 to the second axial end 518 can be precisely controlled and may vary depending on several factors. These factors include the type of raw materials being processed, as different materials may require longer or shorter exposure times to achieve the desired thermal effect. Also, different materials may move or progress more quickly or slowly based on their weight, size, texture, and/or other characteristics. Additionally, aspects of the material motivator—such as the speed of rotation, vibration, or the angle of inclination within the vessel—can be adjusted to control how quickly the raw materials 5 move toward the outlet. By fine-tuning these variables, the system ensures that the raw materials 5 are processed efficiently and uniformly, maintaining optimal thermal conditions throughout their journey through the vessel 500. This continuous process provides a highly efficient method for treating materials, as it minimizes downtime and allows for ongoing input and output of materials.

FIG. 5A shows that the vessel 500 includes an outer drum 510, a material cage 520, and a material motivator in the form of inclined internal surfaces that move material as the material cage 520 rotates 537. The outer drum 510 is defined by an inner volume (e.g., annular space 515 plus caged volume 525) bounded by the two opposed axial ends 512, 518 of the outer drum 510 and a longitudinal side wall 516 of the outer drum 510 extending between the two opposed axial ends 512, 518. The outer drum 510 forms an outer structure of the vessel 500 that encloses the inner volume where the raw materials 5 and working fluid may be contained for thermal processing of the raw materials 5. The outer drum 510 may include any and/or all of the features described above regarding the outer drum (e.g., 310) of earlier embodiments, thus housing the vessel's internal components and facilitating the thermal processing of raw materials 5. As with earlier embodiments, the inner volume is defined as all the space enclosed within the boundaries of the outer drum 510, including the area contained by the longitudinal side wall 516, as well as the space between the opposed axial ends 512, 518 of the outer drum 510.

The material cage 520 is positioned inside the inner volume of the outer drum 510 and defines an outer annular space 515, between the inner surface of the longitudinal side wall 516 of the outer drum 510 and the exterior of the material cage 520. The material cage 520 includes at least one aperture that allows the working fluid to pass between the outside of the material cage 520 (e.g., from the outer annular space 515) to the inside of the material cage 520 (e.g., into a caged volume 525 defined by the space inside the material cage 520). The material cage 520 may incorporate different configurations that provide one or more apertures, such as perforated walls, mesh screens, gridded frameworks, or porous structure, all designed to allow working fluid to pass freely while preventing the raw materials 5 from passing through the material cage 520. In addition, the material cage 520 includes two open axial ends. A first cage end 521 may be axially located at or near the first axial end 512 and a second cage end 529 may be axially located at or near the second axial end 518.

The vessel 500 includes a material motivator in the form of a spiraling grooved inner surface 522 that functions similarly to an auger, facilitating the longitudinal movement of the raw materials 5 through the material cage and eventually out of the second axial end 518. These spiraling grooves of the inner surface 522 are designed to guide and push the raw materials along the length of the material cage 520 as the material cage 520 rotates 537, ensuring a steady progression of the materials toward the exit of the vessel during the thermal process.

The inner surface 522 of the material cage 520 can take on various shapes or forms while still promoting this longitudinal movement. For instance, the grooves could be deeper or shallower, and their pitch could be adjusted to control the speed of material movement. Alternatively, the inner surface 522 could have ribbed, textured, or angled elements, all of which would encourage the raw materials to move in a helical path through the cage. These elements ensure that the raw materials are continuously agitated and shifted, promoting even exposure to the working fluid as they move through the processing environment.

Even though the material cage 520 may be constructed from perforated walls, mesh screens, gridded frameworks, or porous structure, the material used for these structural components can be modified to incorporate or include the spiraling grooves or similar mechanical features. The perforations, mesh, or grid patterns do not inhibit the formation of such grooves or elements; instead, they work in conjunction with them. The perforated surfaces allow the working fluid to pass through the cage and engage with the raw materials, while the spiraling grooves or mechanical elements embedded in these walls actively promote the longitudinal movement of the materials. This design ensures that the material cage 520 serves a dual function—facilitating both the flow of the working fluid and the controlled movement of the raw materials through the vessel. Thus, while enabling fluid flow into the material cage 520 through its aperture(s), the material cage 520 is designed to both restrict and control the movement of raw materials 5. The one or more apertures are configured to prevent the raw materials 5 from escaping through the longitudinally extending walls of material cage 520, while the groves promote movement.

As with earlier embodiments, the material cage 520 may be configured to rotate 537, such as by being driven by a motor (e.g., 350) and belt (e.g., 355), and through support bearings, mounts, and couplings to the first and/or second mounting stands 560, 562. For example, the first and second mounting stands 560, 562 may include bearing surfaces that rotationally support the material cage 520. Like earlier embodiments, a circulating belt, driven by a motor, may wrap around the material cage 520 or a portion thereof to control rotation.

The first mounting stand 560 supports one end of the vessel 500 and may include a feeder opening 570, which functions as the intake for the raw materials 5 being introduced into the vessel 500. This feeder opening 570 may be strategically positioned to ensure a smooth and controlled entry of the materials into the processing system. Once the raw materials are poured or delivered into the feeder opening, they pass through a chute 572, which forms an inner passage that guides the materials directly into the first cage end 521 of the material cage 520. The chute 572 ensures a continuous and regulated flow of the materials, preventing blockages or uneven feeding into the vessel.

The design of the chute 572 also helps maintain the integrity of the thermal process by minimizing spillage and ensuring that all materials are funneled precisely into the material cage 520. As the raw materials enter the first cage end 521, they are then evenly distributed within the caged volume, where they begin to move longitudinally through the vessel for processing. This configuration optimizes the feeding process, providing an efficient transition from the feeder opening 570 to the internal processing area of the vessel, allowing for continuous or batch operation with minimal interruption.

In addition to housing the chute 572 that directs raw materials into the vessel 500, other parts of the first mounting stand 560 may be designed to receive and manage the exiting working fluid flow 139 that is expelled from the vessel during the thermal process. Specifically, regions of the first mounting stand 560 located outside the chute 572 can be configured to collect the exiting working fluid flow 139 from the outer annular space 515, where the working fluid circulates. This expelled fluid may flow into dedicated passages or chambers within the mounting stand 560, ensuring efficient collection of the working fluid as it exits the vessel.

These passages can be engineered to funnel the exiting working fluid into a connected recirculation conduit (e.g., recirculation conduit 107), allowing the working fluid to be directed back into the system for reheating or reuse. This design helps optimize the overall energy efficiency of the system by capturing the expelled working fluid, preventing its loss, and facilitating its reintroduction into the thermal cycle. By incorporating these features into the mounting stand 560, the system ensures that both the flow of raw materials and the handling of working fluid are seamlessly integrated, improving both material handling and energy conservation in the vessel 500.

The second mounting stand 562 support another end of the vessel 500 and may include an output catch 580 that is incorporated into or attached to the second mounting stand 562 and is configured to collect processed material as it is expelled from the vessel 500. As the material motivator moves the raw materials 5 through the material cage 520 during the thermal process, the processed materials eventually reach the second cage end 529 of the material cage 520. Once the materials move past the second cage end 529, they fall directly into the output catch 580.

The output catch 580 may be designed to ensure a smooth and efficient transition from the material cage 520 to the collection point, preventing spillage or loss of the processed materials. Its position relative to the second cage end 529 allows for optimal alignment, ensuring that all materials expelled by the material motivator are captured. The catch can be sized and shaped according to the volume of processed materials expected and may be fitted with sloped surfaces or funnels to guide the materials into storage containers or onto conveyors for further processing, packaging, or transportation. Optionally, the output catch 580 may lead directly to a conveyor, packaging, or other element for further processing and/or transport of the processed materials. This setup simplifies the collection process, ensuring that the thermally processed materials are easily retrieved and/or transported without interrupting the continuous flow of operation.

In some embodiments, part of the material motivator may be incorporated into the first and second mounting stands 560, 562, which can be designed to create an incline for at least the material cage 520 from the horizontal plane. For example, the first mounting stand 560 may maintain the first axial end 512 of the material cage 520 elevated relative to the second axial end 518 of the material cage 520.

In accordance with various embodiments, the direction of any axially or annularly delivered working fluid flow 131, 133 may be opposite to the direction in which the raw materials 5 moves through the material cage 520. For instance, while the raw materials 5 is moved by the material motivator from the first axial end 512 of the material cage 520 toward the second axial end 518, the working fluid may be introduced at the second axial end 518 via the intake manifold 342 and flow in the opposite direction. The intake manifold 342 captures the incoming working fluid flow 131 and distributes it within the vessel 500, such as through flow supply ports 543, as an annular working fluid flow 133 and/or an axial flow (e.g., 135). The annular flow 133 circulates around the exterior of the material cage 520 within the outer annular space 515, before permeating through the apertures of the material cage 520 and entering the caged volume 525. This allows the working fluid to flow into, across, and around the raw materials 5 from multiple directions as it moves toward the first axial end 512. Once the working fluid has circulated through the material cage, it eventually returns to the annular space 515 and exits at the first axial end 512 into the first mounting stand 560.

This opposite directional flow—where the raw materials 5 moves in one direction and the working fluid moves in the other—offers several benefits. First, it promotes countercurrent heat exchange, a highly efficient method for transferring thermal energy. As the hottest working fluid encounters the coolest raw material near the intake, it provides optimal thermal transfer, ensuring the raw material is heated progressively as it moves through the material cage. This arrangement maximizes energy efficiency by maintaining a temperature gradient that encourages consistency and even heat absorption across the entire length of the material cage.

Additionally, moving the raw materials 5 in the opposite direction of the working fluid flow helps to prevent localized overheating of the material near the intake point. By exposing the processed material to cooler working fluid as it nears the exit, the system avoids overheating materials that have already undergone substantial thermal treatment. This method also ensures that all raw materials receive sufficient contact with fresh, heated working fluid, resulting in more uniform processing.

Furthermore, the annular working fluid flow 133 allows the fluid to surround the material cage 520 and permeate from the outside inward, providing comprehensive exposure to the working fluid from multiple directions. This radial flow further enhances heat transfer and promotes more thorough thermal processing of the raw materials. By eventually returning the working fluid to the outer annular space 515 and directing it out through the first axial end 512, the system maintains a continuous and efficient circulation of the working fluid while simultaneously moving the raw materials in the opposite direction, optimizing both material handling and energy use.

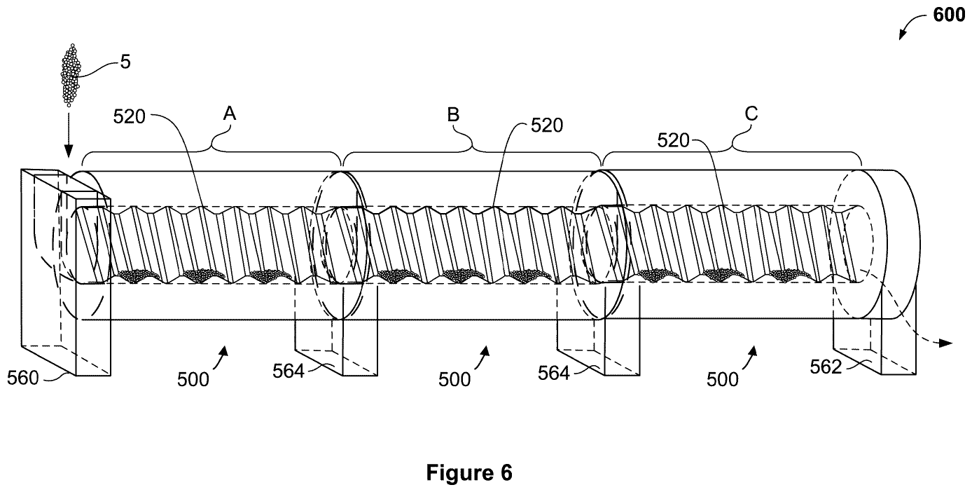

FIG. 6 illustrates a vessel 600 formed from a series of vessels 500 for thermally processing materials continuously in accordance with various embodiments. The vessel 600 represents an example of the vessel 200 described above and is formed from a series of vessels 500 that are coupled together in an end-to-end configuration to provide a longer and more continuous course for thermal processing, in accordance with various embodiments. This series of vessels 500 may be arranged to allow raw materials 5 to travel through each connected vessel, thereby extending the duration and extent of the thermal process, which is particularly beneficial for materials that require longer exposure to heat or complex, multi-stage treatment. This configuration enables the raw materials to undergo progressive processing as they pass through the system, ensuring that each stage of the process is carefully controlled for optimal results.

Alternatively, each of the vessels 500 in the series may be designated to handle a different stage of material processing, such as stages A, B, and C, with each vessel tailored to perform a specific thermal or chemical treatment on the raw materials 5. In stage A, the first vessel may focus on preheating or drying the raw materials, preparing them for subsequent processing by reducing moisture content or lightly heating the materials to an initial temperature. In stage B, the next vessel may perform the main thermal processing, such as roasting, cracking, or baking, where the raw materials are exposed to higher temperatures and more intense thermal treatment. Finally, in stage C, the last vessel in the series may handle the cooling or post-processing phase, gradually reducing the temperature of the processed materials to stabilize them, ensuring that they do not overcook or degrade after the main processing.

To support these varied stages of processing, the system may control the amount and/or rate of delivered working fluid flow into each material cage 520 of the individual vessels 500. This control can ensure that the working fluid flow is optimized for the specific requirements of each stage. For example, in stage A, a lower rate of working fluid flow might be used to gently preheat the materials, while in stage B, a higher volume or faster flow of the working fluid could be applied to achieve the desired roasting or high-temperature treatment. In stage C, the rate of the working fluid flow might be reduced again, or cooler fluid may be introduced to gradually cool down the materials and complete the processing cycle.

This modular approach, with different vessels providing distinct stages of processing, allows for greater customization and flexibility in how raw materials are treated. It also ensures more precise control over temperature profiles, working fluid dynamics, and the overall processing environment, resulting in improved consistency and quality in the final processed materials.

The first and second mounting stands 560, 562 in the vessel configuration may be replaced at the adjoining locations with intermediate support stands 564. These intermediate support stands 564 are designed to provide structural stability and support for the vessel 600 as the raw materials 5 are processed through the series of vessels 500. By reducing the complexity of the mounting stands, the intermediate support stands 564 offer a streamlined approach to supporting the processing system without additional mechanisms.

Alternatively, the intermediate support stands 564 can be configured as output catches, similar to the output catch 580, but designed to collect raw materials that have been sorted by size during processing. These output catches may feature increasingly larger sorting holes, through which progressively larger raw materials drop as they move through the vessel system. The sorting mechanism allows for a more refined collection of materials based on their size or level of processing. As the raw materials 5 travel through the series of vessels, the intermediate support stands 564 equipped with sorting holes can selectively catch materials that meet the size criteria, ensuring that only the appropriately sized materials move on to the next processing stage. This approach not only facilitates better sorting but also enables the collection of processed materials in stages, improving efficiency and product quality control.

FIGS. 7A-7B illustrate a vessel 700 for producing thermally processed materials in accordance with various embodiments. The vessel 700 is illustrated in FIG. 7A without the intake manifold (e.g., 342), outlet manifold (e.g., 348) and/or mounting stands (e.g., 360, 560, 562) for brevity. It should be understood that such elements and other elements described from earlier embodiments may be incorporated into or used with the vessel 700. In this way, the vessel 700 may be used for a batch or a continuous process, depending on how the raw materials 5 are configured to be introduced and/or removed therefrom. The vessel 700 represents an example of the vessel 200 described above and includes an outer drum 710 and an inner tubular member 730 as elements for producing the thermally processed materials.

The outer drum 710 includes two opposed axial ends 712, 718 and a longitudinal side wall 716 extending between them. The outer drum 710 is designed to contain raw materials 5 within its inner volume, specifically in the outer annular space 715 formed between the inner surface of the longitudinal side wall 716 and the outer surface of an inner tubular member 730. This inner tubular member 730 extends through the inner volume of the outer drum 710 and is configured to receive a working fluid as an axially delivered working fluid flow 131 from a remote heating station (e.g., 102, 103). The inner tubular member 730 transfers heat from the working fluid to the raw materials 5 located in the outer annular space 715, facilitating the thermal processing of the materials. The inner tubular member 730 is a tubular structure positioned within the outer drum 710, extending longitudinally through the inner volume. The inner tubular member 730 is configured to receive and convey the working fluid, allowing heat transfer from the fluid to the raw materials held within the outer drum, including an intermediate material cage if included (e.g., vessels 800, 801). The inner tubular member 730 may include apertures 720, which may be formed as simple openings or more defined nozzles, to direct the working fluid and may rotate to enhance heat distribution. The apertures 720 may be configured relative to internal baffling, auger structure, and/or other structure, to allow internal mixing of the heated raw materials.

The inner tubular member 730 includes a series of apertures 720 along its longitudinal length. These apertures 720 are specifically configured to direct the working fluid radially outward into the outer annular space 715, as a radially outward working fluid flow 136, allowing for effective heat transfer to the raw materials 5. This design ensures that the working fluid is evenly distributed throughout the annular space 715, promoting uniform thermal processing of the materials contained in the outer drum 710.

In various embodiments, such as a batch processing embodiment, the outer drum 710 may be equipped with a hatch (e.g., 319) that allows for the convenient addition or removal of the raw materials 5. This hatch also facilitates the removal of thermally processed materials after the processing cycle is complete, providing easy access to the contents of the vessel 700.

The inner tubular member 730 may also be configured to rotate within the outer drum 710, enhancing the flow of the working fluid and improving the consistency of heat transfer. This rotation helps to evenly distribute the working fluid and ensures that the raw materials 5 are uniformly exposed to the heated environment, resulting in more efficient thermal processing within the vessel 700.

The inner tubular member 730 may include a material motivator in the form of one or more paddles 722 that protrude radially from its surface. These paddles 722 are attached at their base to the inner tubular member 730 and are designed to rotate along with the inner tubular member. As the inner tubular member 730 rotates, the paddles 722 rotate within the annular space 715, effectively mixing the raw materials 5 contained in that space. This mixing action helps ensure that the raw materials are evenly exposed to the working fluid, promoting uniform heat transfer throughout the thermal processing.

In addition to mixing, the rotation of the paddles 722 can also move the raw materials 5 along the longitudinal extent of the vessel 700. This movement is particularly beneficial for continuous processing, where the raw materials need to be transported from the intake point (e.g., the first axial end 712) to the exit point (e.g., the second axial end 718) while being processed.

Alternatives to paddles that could be used to mix or move the raw materials 5 include augers, which could spiral along the inner tubular member 730, pushing the materials along the vessel as they rotate. Additionally, ribs or fins could be integrated into the outer surface of the inner tubular member to create agitation and encourage the materials to move as the inner tubular member 730 rotates. Another option is the use of vibratory mechanisms attached to the inner tubular member 730, which would induce vibrations to both mix and move the raw materials 5 along the vessel 700. These alternatives provide various ways to enhance the movement and uniform processing of the raw materials 5 inside the vessel 700.

FIGS. 8A-8C illustrate vessels 800, 801 for producing thermally processed materials in accordance with various embodiments. The vessels 800, 801 incorporate and combine elements of the vessels 300, 301, 302 with vessels 700 described above. In particular, the vessels 800, 801 include the outer drum 310, the material cage 320, and the material motivator in the form of the motor 350 configured to rotate 337 the material cage 320. This configuration ensures that the raw materials 5 inside the material cage 320 are agitated and exposed to the working fluid, promoting uniform heat transfer throughout the process.

A notable addition to these vessels is the incorporation of an inner tubular member 730 within the material cage 320. The placement of the inner tubular member 730 creates an intermediate annular space 825 between the inner tubular member 730 and the material cage 320. This intermediate annular space 825 becomes the primary zone for housing the raw materials 5 during the thermal process, with the working fluid circulating through this space to heat the materials.

In the vessels 800 and 801, the working fluid is introduced into the system through the inner tubular member 730 as an axially delivered working fluid flow 131 from a remote heating station, such as solar concentrators (e.g., 102) or a concentrated solar receiver (e.g., 103). The working fluid flows into the inner tubular member 730, where it begins to transfer heat radially outward into the intermediate annular space 825, which contains the raw materials 5. The apertures 720 along the inner tubular member allow the heated working fluid to pass through into the intermediate annular space 825, evenly distributing the heat across the raw materials 5 and facilitating the desired thermal processing.

FIG. 8B shows how for the vessel 800, once the working fluid has circulated through the intermediate annular space 825 and has transferred its heat to the raw materials 5, it may exit the vessel 800. In particular, the recirculation conduit 107 may carry away the exiting working fluid flow 139. From there, the working fluid can be handled in several ways depending on the process design. It may be recirculated back into the vessel for further use, sent to a storage reservoir such as 120 for later heating, or returned to the remote heating station, such as solar concentrators 102, to be reheated and reintroduced into the system. This efficient use of the working fluid maximizes energy conservation and allows for a continuous or semi-continuous process.

FIG. 8C illustrates an embodiment of vessel 801 in which the longitudinal side wall 316 of the outer drum 310 is equipped with one or more radial apertures 344. These radial apertures 344 are strategically positioned to allow for the release of a radially removed working fluid flow 138 from both the outer annular space 315 and the caged volume 325. The radial apertures 344 facilitate the controlled removal of the working fluid after it has passed through and transferred heat to the raw materials 5 inside the vessel.

Conduits 104 are coupled to the radial apertures 344, enabling the precise removal of the working fluid at multiple points along the length of the vessel 801. This configuration provides several benefits. First, it ensures that the working fluid can be evacuated at optimal locations based on the stage of processing, preventing potential buildup or uneven distribution of fluid within the vessel. By allowing the working fluid to exit radially at these various points, the system can maintain a consistent flow, optimizing the efficiency of the thermal process.

Furthermore, this radial removal of the working fluid can improve thermal control within the vessel. As the working fluid is removed through conduits 104, it prevents overheating or the accumulation of exhausted fluid that may have already transferred a significant portion of its heat. This allows for the introduction of fresh working fluid, ensuring that the raw materials 5 continue to receive heat evenly as they move through the vessel. The ability to remove working fluid radially along different points of the vessel ensures that temperature profiles can be finely tuned, contributing to the overall uniformity of processing.

Additionally, the radial apertures 344 and the associated conduits 104 support the effective handling of the exiting fluid. The removed working fluid can be routed through the conduits 104 to a recirculating system, where it can either be reheated and reintroduced to the vessel or directed to a storage reservoir or other treatment stage. This capability adds another layer of control over the fluid flow, ensuring that energy usage is optimized and that the thermal processing remains efficient throughout the operation of the vessel 801.

As the thermal processing of the raw materials 5 proceeds, they are agitated and mixed within the intermediate annular space 825 due to the rotation of the material cage 320. The material motivator, whether in the form of paddles (e.g., 722) attached to the inner tubular member 730 or other mechanisms such as augers, further ensures that the materials are evenly exposed to the heated working fluid. This process can continue for a specified period, depending on the nature of the materials and the desired level of thermal treatment.

Once the raw materials 5 have been thermally processed to the desired degree, they can be removed from the material cage 320 via hatches, allowing for easy unloading. After the processed batch is removed, the vessel 800, 801 can be quickly reloaded with another batch of raw materials 5, either to repeat the process or to begin processing a new set of materials. The system's design allows for flexibility in batch processing or continuous operation, depending on the needs of the user. With the combined features of the vessels described above, vessels 800 and 801 offer a robust, energy-efficient, and adaptable solution for producing thermally processed materials using solar-powered or other working fluid systems.

Alternatively, the vessels 800, 801 may include internal tubing that extends from the delivery conduit 104 to one or more specific apertures 720 within the inner tubular member 730. This tubing directs the working fluid flow to targeted areas within the intermediate annular space 825 in a radial direction, ensuring that the fluid reaches specific zones inside the material cage 320 where the raw materials 5 are concentrated. By channeling the fluid in this manner, the system provides a more focused and directed flow, enhancing the contact between the working fluid and the raw materials 5. This configuration allows for precise control over the flow dynamics within the material cage 320, promoting uniform exposure and improving heat transfer efficiency.

FIG. 9 illustrates a vessel 900 for producing thermally processed materials in accordance with various embodiments. The vessel 900 is illustrated without the intake manifold (e.g., 342), outlet manifold (e.g., 348) and/or mounting stands (e.g., 360, 560, 562) for brevity. It should be understood that such elements and other elements described from earlier embodiments may be incorporated into or used with the vessel 900. In this way, the vessel 900 may be used for a batch or a continuous process, depending on how the raw materials 5 are configured to be introduced and/or removed therefrom. The vessel 900 represents an example of the vessel 200 described above and includes an outer drum 310 and the inner tubular member 730 as elements for producing the thermally processed materials.

The inner tubular member 730 in vessel 900 may further include a material motivator in the form of an auger 922 that protrudes radially from its surface. The auger 922 spirals around and is attached at its base to the inner tubular member 730, designed to rotate in unison with the inner tubular member 730. As the inner tubular member 730 rotates, the auger 922 likewise rotates within the intermediate annular space 825 inside the material cage 320, effectively mixing the raw materials 5 contained in that space. This mixing action ensures that the raw materials are evenly exposed to the working fluid, thus promoting uniform heat transfer throughout the thermal processing. In addition to mixing, the rotation of the auger 922 also serves to move the raw materials 5 along the longitudinal extent of the vessel 900. This movement is particularly advantageous for continuous processing, where the raw materials need to be gradually transported from the intake point (e.g., the first axial end 312) to the exit point (e.g., the second axial end 318) as they undergo processing. The auger-driven transport mechanism ensures that the materials are efficiently processed and expelled at the appropriate time, contributing to the system's versatility for both batch and continuous operations.

FIG. 10 illustrates a vessel 1000 formed from a series of vessels 900 for thermally processing materials continuously in accordance with various embodiments. The vessel 1000 represents an example of the vessel 200 described above and is formed from a series of vessels 900 that are coupled together in an end-to-end configuration to provide a longer and more continuous course for thermal processing, in accordance with various embodiments. This series of vessels 900 may be arranged to allow raw materials 5 to travel through each connected vessel, thereby extending the duration and extent of the thermal process, which is particularly beneficial for materials that require longer exposure to heat or complex, multi-stage treatment. This configuration enables the raw materials to undergo progressive processing as they pass through the system, ensuring that each stage of the process is carefully controlled for optimal results.

The operations, alternatives, and advantages described for vessels 500, 600 can also be applied to vessel 1000. Like the vessel 600 and the series of vessels 500, vessel 1000 can be used in a staged processing configuration, with each stage (A, B, and C) designated for specific treatments such as preheating, main thermal processing, and cooling. The system may control the working fluid flow to optimize each stage, with lower flow for preheating, higher flow for intense thermal treatments like roasting, and reduced flow or cooler fluid for cooling. This modular approach allows for customized processing of raw materials 5, providing precise temperature control and improving product consistency and quality. Additionally, intermediate support stands 564 may replace more complex mounting stands, offering structural stability and optional output catches that sort and collect processed materials based on size, further enhancing efficiency and product control in vessel 1000.

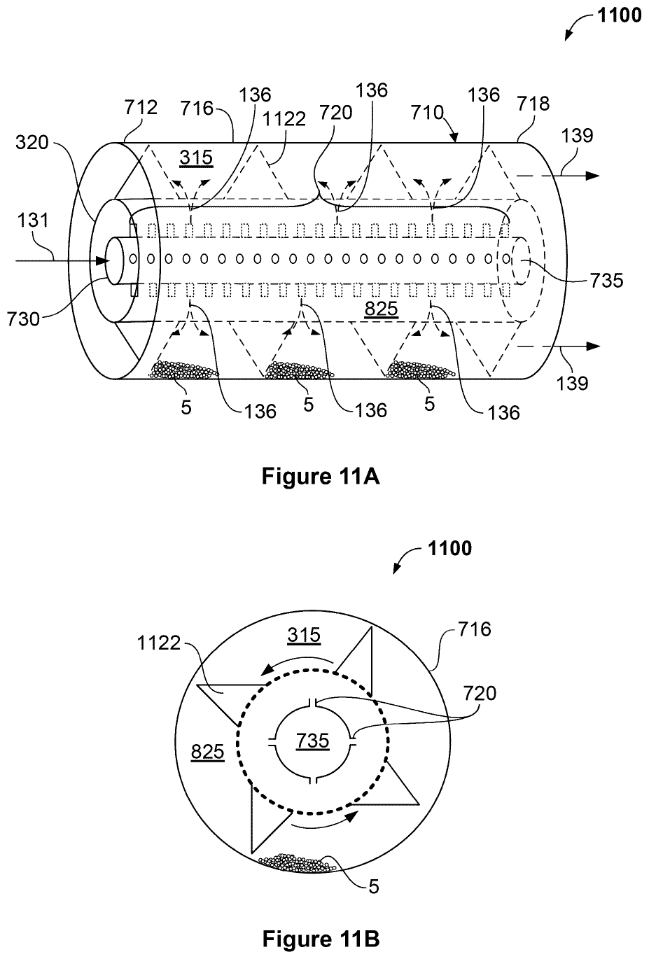

FIGS. 11A-11B illustrate a vessel 1100 for producing thermally processed materials in accordance with various embodiments. The vessel 1100 is illustrated in FIG. 11A without the intake manifold (e.g., 342), outlet manifold (e.g., 348) and/or mounting stands (e.g., 360, 560, 562) for brevity. It should be understood that such elements and other elements described from earlier embodiments may be incorporated into or used with the vessel 1100. In this way, the vessel 1100 may be used for a batch or a continuous process, depending on how the raw materials 5 are configured to be introduced and/or removed therefrom. The vessel 1100 represents an example of the vessel 200 described above and includes an outer drum 710, a material cage 320, and an inner tubular member 730 as elements for producing the thermally processed materials.

Vessel 1100 is a variation of vessel 700, with key differences in how it handles the material cage 320 and the placement of the raw materials 5. In vessel 1100, the raw materials 5 are placed outside the material cage 320, but within the longitudinal side wall 716 of the vessel. This design creates a large outer annular space 315 between the material cage 320 and the longitudinal side wall 716, where the raw materials 5 reside during processing. The working fluid, which is introduced into this outer annular space 315, flows around the raw materials 5, facilitating their thermal treatment.

Unlike the paddle configuration in vessel 700, which has paddles located on the inner tubular member 730, vessel 1100 features paddles 1122 mounted on the outer surface of the material cage 320. These paddles 1122, which are radially protruding from the material cage 320, serve as a material motivator. They are attached at their base to the material cage 320 and rotate along with it as the cage is driven by the system's motor. As the material cage 320 rotates, the paddles 1122 also rotate within the outer annular space 315, where they interact with the raw materials 5.

This rotation of the paddles 1122 ensures that the raw materials 5 are effectively mixed as they move through the outer annular space 315. By continuously agitating the materials, the paddles promote uniform exposure of the raw materials to the heated working fluid. This mixing action is critical for ensuring consistent heat transfer, as it prevents the materials from settling or clustering together, which could result in uneven processing. The constant movement of the materials within the annular space also improves the efficiency of the working fluid, allowing it to flow freely around and between the raw materials.

The design of vessel 1100, with paddles 1122 on the outside of the material cage 320, provides several advantages. First, it cages off the raw materials 5 from the apertures 720, thus preventing them from getting clogged. Second, it enables more effective mixing of larger batches of raw materials, as the paddles interact directly with the bulk of the material in the outer annular space. Third, the arrangement allows for optimized heat transfer, as the paddles continually push and redistribute the raw materials, ensuring that each part of the batch is evenly exposed to the working fluid. Additionally, the rotating material cage 320 with paddles 1122 helps prevent blockages or clumping of materials, maintaining a smooth flow throughout the thermal process.

Overall, vessel 1100 represents a more dynamic and efficient system for thermally processing raw materials. By placing the raw materials outside the material cage 320 and incorporating paddles 1122 on the material cage, the vessel enhances both the mixing of the materials and their exposure to the working fluid, ensuring uniform and consistent thermal processing. This configuration is especially useful for applications where thorough mixing and heat distribution are critical to achieving high-quality results in the processed materials.

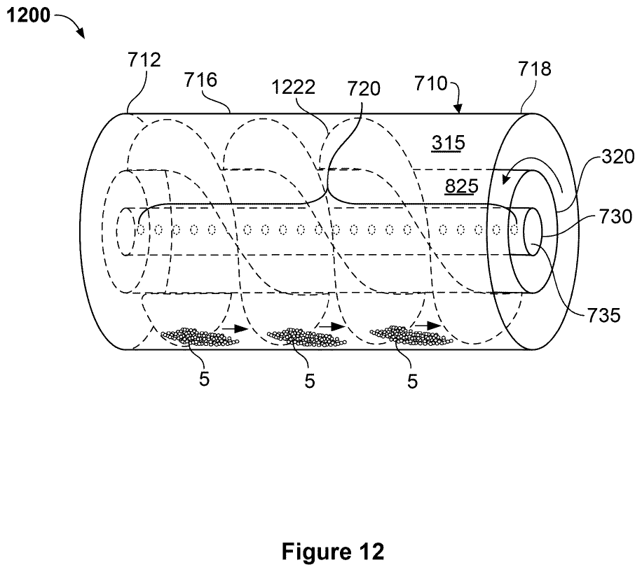

FIG. 12 illustrates a vessel 1200 for producing thermally processed materials, which incorporates an auger 1222 attached to the outside of the material cage 320. In this embodiment, the raw materials 5 are loaded into the outermost annular space 315, located outside the material cage 320. The auger 1222, which is radially attached to the exterior of the material cage 320, spirals along the length of the cage and is designed to rotate along with it. As the material cage 320 rotates, the auger 1222 also rotates within the outer annular space 315, engaging with and mixing the raw materials 5 in that space.

This design ensures that the raw materials 5 are continuously mixed and agitated during the thermal process, promoting even exposure to the working fluid circulating within the vessel 1200. The auger 1222's spiral configuration helps ensure that the materials do not settle or clump together, facilitating uniform heat transfer across the entire batch of materials. The consistent movement provided by the rotating auger 1222 allows for optimal thermal processing, ensuring that all raw materials are effectively exposed to the heated working fluid.

In addition to mixing, the auger 1222 also serves the material motivator, providing a transport function, moving the raw materials 5 along the longitudinal axis of the vessel 1200. This feature is especially beneficial in continuous processing applications, where the raw materials must be gradually advanced from the intake point (e.g., the first axial end 712) to the exit point (e.g., the second axial end 718). As the auger 1222 rotates, it propels the raw materials forward, ensuring that they are processed efficiently and reach the exit point at the appropriate time. This transport mechanism enhances the versatility of vessel 1200, making it suitable for both batch and continuous operations, depending on how the materials are introduced and removed from the system.

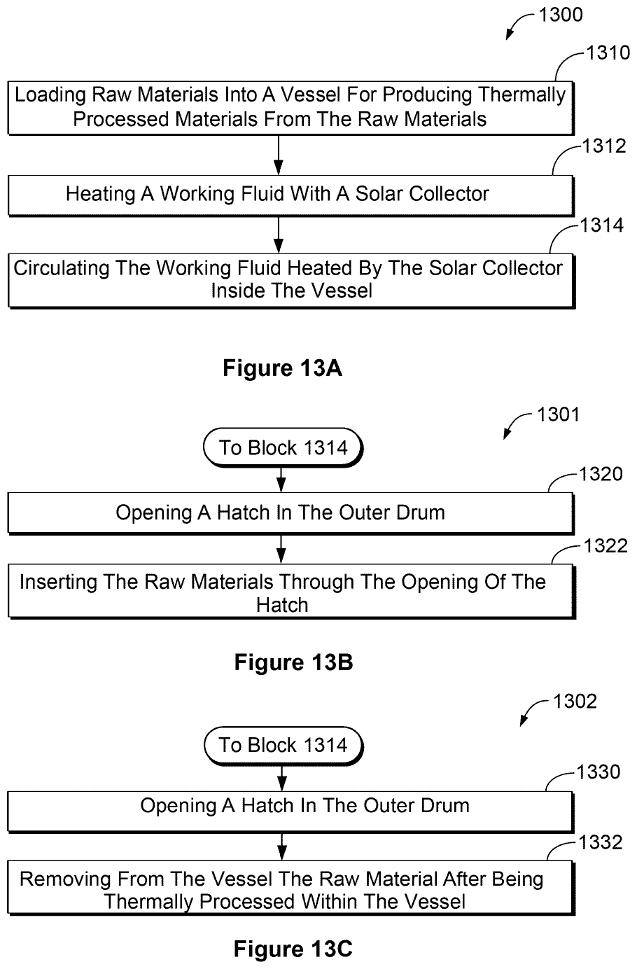

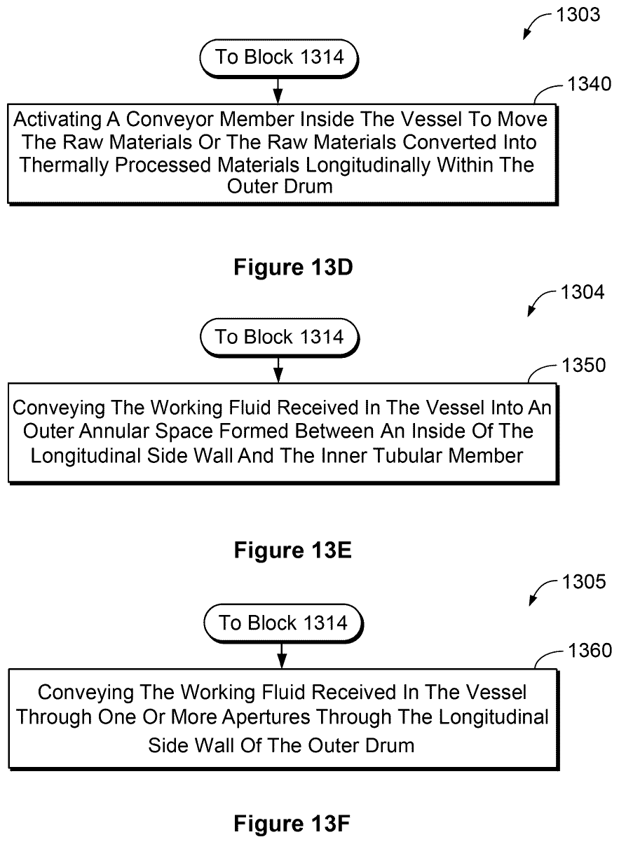

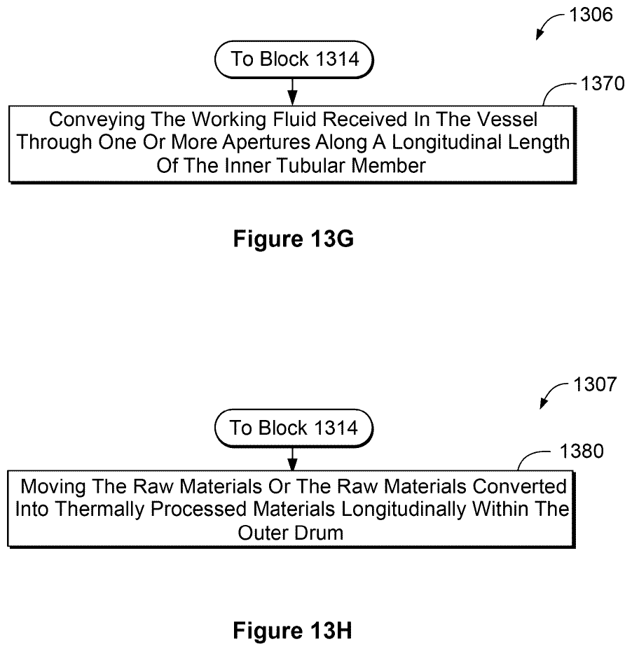

FIGS. 13A-13H are process flow diagrams illustrating example methods 1300-1307 of producing thermally processed materials in accordance with various embodiments. With reference to FIGS. 13A-13H, the methods 1300-1307 and the operations thereof may be performed using vessels 200, 300, 301, 302, 400, 500, 600, 700, 800, 801, 900, 1000, 1100, 1200. In some embodiments, the methods 1300-1307 may be performed with the assistance of automation or added automated elements. The operations of the methods 1300-1307 may be controlled by an operator or performed by a processor of the system controller 160, or a combination thereof. In this way, the vessels 200, 300, 301, 302, 400, 500, 600, 700, 800, 801, 900, 1000, 1100, 1200 and/or systems 100, 201 may be run as a non-autonomous, semi-autonomous, or fully autonomous systems.

Referring to FIG. 13A, in the method 1300, the vessel of any of the various embodiments described herein may be loaded with raw materials for producing thermally processed materials from the raw materials in block 1310. For example, a vessel may consist of an outer drum with two opposed axial ends and a longitudinal side wall connecting the ends. Inside the drum, an inner tubular member runs through the inner volume, which is designed to hold raw materials. A solar collector is used to heat a working fluid, and heat transfer pipes are arranged to carry the heated working fluid from the solar collector into the vessel. Once inside, the working fluid heats the raw materials, facilitating their thermal processing.

In block 1312, the working fluid is heated using a solar collector, which captures and concentrates sunlight to elevate the temperature of the working fluid. The solar collector, typically a parabolic trough or heliostat, focuses solar energy onto a receiver containing the fluid, heating it efficiently without the use of fossil fuels. This environmentally friendly method of heating allows the system to use renewable energy for the thermal processing of materials, significantly reducing carbon emissions and overall energy costs.

In block 1314, the heated working fluid from the solar collector is circulated inside the vessel. The working fluid, now at a high temperature, is introduced into the system where it transfers heat to the raw materials contained within the vessel. This circulation process ensures that the working fluid surrounds and permeates the raw materials, facilitating efficient thermal processing. The heat transfer is controlled to maintain the desired temperature, promoting uniform treatment of the materials as they undergo heating.

Referring to FIG. 13B, in the method 1301, following the operations in block 1314, in block 1320, the raw materials are loaded into the vessel by opening a hatch in the outer drum. The hatch, which is located on the longitudinal side of the outer drum, provides access to the internal space of the vessel, allowing raw materials to be introduced for processing. The hatch is designed for ease of operation, ensuring minimal disruption to the system during loading.

In block 1322, the raw materials are inserted through the open hatch into the vessel. Once the hatch is opened, the raw materials can be manually or mechanically inserted into the designated processing area, typically within the outer annular space. This step ensures that the materials are correctly positioned for effective exposure to the working fluid as it circulates through the vessel during the thermal process.

Referring to FIG. 13C, in the method 1302, following the operations in block 1314, in block 1330, a hatch in the outer drum may again be opened to access the contents of the vessel. This step allows for the removal of the raw materials after they have completed the thermal process, ensuring that the materials can be easily retrieved without dismantling the system. The design of the hatch allows for efficient access while maintaining the integrity of the vessel's sealed environment during processing.

In block 1332, the thermally processed raw materials are removed from the vessel through the open hatch. Once the materials have been fully processed, the hatch is opened, and the materials are manually or automatically removed. This step marks the conclusion of the thermal process, after which the materials may be packaged, further processed, or prepared for transportation.

Referring to FIG. 13D, in the method 1303, following the operations in block 1314, in block 1340, a conveyor member inside the vessel is activated to move the raw materials, or the thermally processed materials, longitudinally within the outer drum. This conveyor system ensures that the materials are steadily moved along the length of the vessel, facilitating continuous processing. The conveyor can be an auger, paddle, or belt system, and its movement ensures consistent exposure of the materials to the working fluid.

Referring to FIG. 13E, in the method 1304, following the operations in block 1314, in block 1350, the working fluid is conveyed into an outer annular space formed between the inner tubular member and the inner surface of the longitudinal side wall of the outer drum. The working fluid enters this space through at least one axial end of the outer drum, creating a controlled flow around the raw materials. This annular space allows the fluid to circulate evenly, optimizing the heat transfer process.

Referring to FIG. 13F, in the method 1305, following the operations in block 1314, in block 1360, the working fluid passes through apertures in the longitudinal side wall of the outer drum. These apertures are specifically designed to direct the working fluid radially inward, ensuring that it flows towards the inner tubular member. This inward flow pattern improves the distribution of heat across the raw materials, ensuring uniform thermal treatment.

Referring to FIG. 13G, in the method 1306, following the operations in block 1314, in block 1370, the working fluid is conveyed through apertures along the inner tubular member. These apertures are configured to direct the working fluid radially outward from the inner tubular member, into the surrounding annular space. The outward flow from the inner tubular member ensures thorough contact between the working fluid and the raw materials, promoting effective heat transfer.

Referring to FIG. 13H, in the method 1307, following the operations in block 1314, in block 1380, the raw materials are moved longitudinally within the outer drum, either by the conveyor system or through the rotation of the vessel itself. This movement ensures that the materials progress steadily through the processing environment, receiving consistent exposure to the heated working fluid. This longitudinal motion may be used for both batch and continuous processes, ensuring that the materials are uniformly processed as they move through the vessel.

Various embodiments illustrated and described are provided merely as examples to illustrate various features of the claims. However, features shown and described with respect to any given embodiment are not necessarily limited to the associated embodiment and may be used or combined with other embodiments that are shown and described. Further, the claims are not intended to be limited by any one example embodiment. For example, one or more of the elements described regarding vessels 200, 300, 301, 302, 400, 500, 600, 700, 800, 801, 900, 1000, 1100, 1200 may be substituted for or combined with one or more elements of the vessels 200, 300, 301, 302, 400, 500, 600, 700, 800, 801, 900, 1000, 1100, 1200, and vice versa.

The foregoing method descriptions and the process flow diagrams are provided merely as illustrative examples and are not intended to require or imply that the operations of various embodiments must be performed in the order presented. As will be appreciated by one of skill in the art the order of operations in the foregoing embodiments may be performed in any order. Words such as “thereafter,” “then,” “next,” etc., are not intended to limit the order of the operations; these words are used to guide the reader through the description of the methods. Further, any reference to claim elements in the singular, for example, using the articles “a,” “an,” or “the” is not to be construed as limiting the element to the singular.

Various illustrative logical blocks, modules, circuits, and algorithm operations described in connection with the embodiments disclosed herein may be implemented as electronic hardware, computer software, or combinations of both. To clearly illustrate this interchangeability of hardware and software, various illustrative components, blocks, modules, circuits, and operations have been described above generally in terms of their functionality. Whether such functionality is implemented as hardware or software depends upon the particular application and design constraints imposed on the overall system. Skilled artisans may implement the described functionality in varying ways for each particular application, but such embodiment decisions should not be interpreted as causing a departure from the scope of the claims.

In one or more embodiments, the functions described may be implemented in hardware, software, firmware, or any combination thereof. If implemented in software, the functions may be stored as one or more instructions or code on a non-transitory computer-readable storage medium or non-transitory processor-readable storage medium. The operations of a method or algorithm disclosed herein may be embodied in a processor-executable software module or processor-executable instructions, which may reside on a non-transitory computer-readable or processor-readable storage medium. Non-transitory computer-readable or processor-readable storage media may be any storage media that may be accessed by a computer or a processor. By way of example but not limitation, such non-transitory computer-readable or processor-readable storage media may include RAM, ROM, EEPROM, FLASH memory, CD-ROM or other optical disk storage, magnetic disk storage or other magnetic storage smart objects, or any other medium that may be used to store desired program code in the form of instructions or data structures and that may be accessed by a computer. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above are also included within the scope of non-transitory computer-readable and processor-readable media. Additionally, the operations of a method or algorithm may reside as one or any combination or set of codes and/or instructions on a non-transitory processor-readable storage medium and/or computer-readable storage medium, which may be incorporated into a computer program product.

The invention being thus described, it will be obvious that the same may be varied in many ways. Such variations are not to be regarded as a departure from the spirit and scope of the invention, and all such modifications as would be obvious to one skilled in the art are intended to be included within the scope of the appended claims. It is intended that the scope of the invention be defined by the claims appended hereto. The entire disclosures of all references, applications, patents, and publications cited above are hereby incorporated by reference.

In addition, many modifications may be made to adapt a particular situation or material to the teachings of the disclosure without departing from the essential scope thereof. Therefore, it is intended that the disclosure is not limited to the particular embodiment disclosed as the best mode contemplated for carrying out this disclosure, but that the disclosure will include all embodiments falling within the scope of the appended claims.

What is claimed is:

1. A vessel for producing thermally processed materials, comprising:
an outer drum defined by an inner volume bounded by two opposed axial ends of the outer drum and a longitudinal side wall of the outer drum extending between the two opposed axial ends;
a material cage disposed inside the inner volume of the outer drum, wherein the material cage includes at least one aperture configured to allow the working fluid to pass between an inside and an outside of the material cage, wherein the material cage is configured to restrict raw materials from moving between the inside and the outside of the material cage, wherein an outer annular space is formed between an inside of the longitudinal side wall of the outer drum and an outside of the material cage; and
a material motivator configured to facilitate movement of the raw material held in the material cage while the working fluid is received in the inner volume of the outer drum from a remote working fluid heating station.

2. The vessel of claim 1, wherein the working fluid is received into the outer annular space through at least one of the axial ends of the outer drum.

3. The vessel of claim 1, wherein the working fluid is received into the inside of the material cage.

4. The vessel of claim 1, wherein the outer drum includes one or more apertures through the longitudinal side wall of the outer drum configured to direct the received working fluid radially in toward the material cage.

5. The vessel of claim 1, wherein the outer drum includes a hatch for adding the raw materials or removing thermally processed materials.

6. The vessel of claim 1, wherein the material motivator includes a rotational assembly configured to rotate the material cage inside the outer drum.

7. The vessel of claim 1, wherein the material motivator is selected from the group consisting of a rotary auger, a paddle conveyor, a pneumatic conveyor, a vibratory conveyor, and an inclined slide surface.

8. The vessel of claim 1, wherein the material cage includes a planar engagement surface configured to directly support the raw materials.

9. A solar processing system for producing thermally processed materials, comprising:
a vessel comprising:
an outer drum having two opposed axial ends and a longitudinal side wall extending between the two opposed axial ends; and
an inner tubular member extending through an inner volume of the outer drum,
wherein the outer drum is configured to contain raw materials in the inner volume;
a solar collector configured to heat a working fluid; and
heat transfer pipes configured to convey the working fluid heated by the solar collector into the vessel, wherein the working fluid received in the vessel is configured to heat the raw materials for thermal processing.

10. The solar processing system of claim 9, wherein the solar collector is selected from the group consisting of a parabolic trough, a solar collector dish, a Fresnel mirror, and a heliostat.

11. The solar processing system of claim 9, further comprising:
a storage tank configured to hold working fluid therein, wherein the storage tank is connected to the heat transfer pipes between the solar collector and the vessel.

12. The solar processing system of claim 11, wherein the vessel includes an exit port configured to remove working fluid from the vessel after heating the raw materials, wherein the heat transfer pipes are configured to convey at least a portion of the removed working fluid to the storage tank.

13. The solar processing system of claim 9, wherein the vessel includes an exit port configured to remove working fluid from the vessel after heating the raw materials, wherein the heat transfer pipes are configured to convey at least a portion of the removed working fluid to be heated by the solar collector.

14. The solar processing system of claim 9, wherein an outer annular space is formed between an inside of the longitudinal side wall and the inner tubular member, wherein the working fluid is first received into the outer annular space through at least one of the axial ends of the outer drum.

15. The solar processing system of claim 9, wherein the outer drum includes one or more apertures through the longitudinal side wall of the outer drum configured to direct the received working fluid radially in toward the inner tubular member.

16. A method of producing thermally processed materials, comprising:
loading raw materials into a vessel for producing thermally processed materials from the raw materials, wherein the vessel comprises:
an outer drum having two opposed axial ends and a longitudinal side wall extending between the two opposed axial ends; and
an inner tubular member extending through an inner volume of the outer drum, wherein the outer drum is configured to contain the raw materials in the inner volume;
heating a working fluid with a solar collector; and
circulating the working fluid heated by the solar collector inside the vessel,
wherein the working fluid received in the vessel is configured to heat the raw materials for thermal processing.

17. The method of claim 16, wherein loading the raw materials into the vessel comprises:
opening a hatch in the outer drum; and
inserting the raw materials through the opening of the hatch.

18. The method of claim 16, further comprising;
opening a hatch in the outer drum; and
removing from the vessel the raw material after being thermally processed within the vessel.

19. The method of claim 16, further comprising;
activating a conveyor member inside the vessel to move the raw materials or the raw materials converted into thermally processed materials longitudinally within the outer drum.

20. The method of claim 16, further comprising:
conveying the working fluid received in the vessel into an outer annular space formed between an inside of the longitudinal side wall and the inner tubular member, wherein the working fluid is first received into the outer annular space through at least one of the axial ends of the outer drum.

21. The method of claim 16, further comprising:
conveying the working fluid received in the vessel through one or more apertures through the longitudinal side wall of the outer drum, wherein the one or more apertures are configured to direct the received working fluid radially in toward the inner tubular member.

22. The method of claim 16 further comprising:
conveying the working fluid received in the vessel through one or more apertures along a longitudinal length of the inner tubular member, wherein the one or more apertures are configured to direct the received working fluid radially out into the inner volume.

23. The method of claim 16, further comprising:
moving the raw materials or the raw materials converted into thermally processed materials longitudinally within the outer drum.
